(19) United States
(12) Patent Application Publication
(10) Pub. No.: US 2014/0257741 A1
(43) Pub. Date: Sep. 11, 2014

(54) WEIGHTLESS SCALE SYSTEM

(71) Applicant: Christopher Chupp, O'Fallon, MO (US)

(72) Inventor: Christopher Chupp, O'Fallon, MO (US)

(21) Appl. No.: 13/815,516

(22) Filed: Mar. 8, 2013

(51) Int. Cl. G01G 19/44; G01G 19/50

(52) U.S. Cl. CPC G01G 19/44; G01G 19/50
USPC 702/131; 702/173; 702/166

(57) ABSTRACT

A weightless scale system provides a selectable display of actual or differential measurements of body composition factors and has a scrollable calendar whereby a user can select any reference date back to the initial use of the weightless scale system for the one or more differential measurements selectable by the user. Body composition factors include body weight, body mass, body muscle, % water, height and a photographic capability for recording a selectable picture range of the user. The weightless scale system can be used with a single or dual display screens. Certain body composition factors can selectably be measured for a user's whole body or for a specific body part. Methods are described for setup and use of the weightless scale system. Wireless network weightless scale systems are also described for use of the weightless scale system in local and wide area networks and with the Internet.

### BACKGROUND OF THE DISCLOSURE

Some conventional scales, such as bathroom scales, display a user's weight and can display also a differential weight. “Differential” as used herein refers to a measurement that is referenced back to a benchmark or reference measurement, with only the difference between the two measurements displayed as the differential measurement.

However, these scales have provided only a weight measurement or a limited amount of additional body composition factor measurements, and are further limited as to the time range available for the use of stored weight information. Such conventional scales are also limited in the use of a wireless connection only between the weighing platform and a nearby display. As a result, a user's options in the use of a scale, such as a bathroom or a facility-located scale, have been restricted and do not provide a full range of use capabilities, both locally and remotely, for weight and other body composition factors. This causes a problem in having to use other pieces of body composition measurement equipment to get readings of other health-related factors. This requires the user to often have go to other locations both to have other measurements performed and to discuss, analyze or conference with others regarding any of the weight readings, such as trends, as well as the same obstacles for other of the heretofore limited body composition measurements made over time.

### SUMMARY OF THE DISCLOSURE

The present disclosure describes a weightless scale system that has the capability to perform a variety of body composition measurements, to store the measurements over practically a limitless time period, to generate data trends for any or all measurements selectable by the user, and to communicate this information beyond the location of the weightless scale. “Weightless scale” as used herein refers to the scale system of this disclosure which includes, with its other benefits, the providing of a display, at the option of the user, of just the differential weight or other one or more measurement from a reference date, or over a range of dates, as selected by the user.

One embodiment of the disclosure is a weightless scale system. The weightless scale system includes: a platform that is configured to support an item to be weighed, to measure weight and output a weight data of the item as a body composition factor measurement. The system further includes a computer operatively connected to the platform for receiving and processing the weight data from the platform, and outputting processed data, and a memory operatively connected to the computer for storing the weight data with a date associated with each stored weight data. The system still further includes a display operatively connected to the computer for receiving the processed data from the computer and using the processed data to display a selected weight measurement on a display screen; and a control panel operable by a user to select an actual or a differential weight for display. The differential weight is defined as a difference between a most recent weight data outputted from the platform and a weight data outputted from the platform from a selected earlier date. The computer includes a scrollable calendar program configured to allow the user to select at least one calendar date as a benchmark date for calculating the differential weight based on the selected benchmark date when the user selects the differential weight for display. The selectable one calendar date is any date from the date the weightless scale system was first used and weight data was stored in the memory to the date of a most recent weighing on the weightless scale system.

The item to be weighed is usually a person and the system's memory is incorporated into the computer. The user can select two calendar dates to identify a range of dates for measuring a differential weight. The control panel includes a touch screen touchable by the user to activate user selections as part of a display screen on which a weight measurement is displayed.

The scale system includes at least one system for performing a measurement of at least one body composition factor, selectable by the user, from the group of body mass, body muscle, % water, body temperature and body height, and a camera system for taking a picture of at least a portion of the item weighed on the weightless scale system, with data associated with any of the measurement selections is selectable by the user for storage and display in the scale system. Infrared technology can be used as a body composition factor measurement system. The scale system also has at least one control operable by one from the group of a gesture, a sound and a remote control, without a physical touching of the at least one control on the control panel by the user, and the sound can be the user's voice. The scale system can also include multiple displays that are separate from one another, and the platform can include a converter for converting a measured weight to a digital output signal.

Another embodiment discloses a method of using a weightless scale system that includes steps of positioning an item on a platform of the weightless scale system, selecting a differential weight measurement from a choice of an actual or a differential weight measurement, designating a benchmark date from a scrollable calendar of the weightless scale system wherein the scrollable calendar comprises all dates from the time data was first stored in a memory of the weightless scale system, and viewing a differential weight on the display as the difference between a current weight and a stored weight associated with the designated benchmark date.

In yet another embodiment of the disclosure, a wireless network weightless scale system is taught that includes the components of the weightless scale system according to the first aspect of the disclosure, and a wireless network access controller operatively connected to the weightless scale system, an access point connected to the wireless network access controller, and a wireless connection to the access point configured to connect the weightless scale system to a wireless network.

According to the third aspect, the wireless network can be a local area network, a wide area network or the Internet.

### BRIEF DESCRIPTION OF THE DRAWINGS

FIG. 1 is a block diagram of components of the weightless scale system in one embodiment;

FIG. 2 shows a wired connection in FIG. 2A, and a wireless connection in FIG. 2B, between the scale's platform and its display;

FIG. 3 is a block diagram showing certain computer components in one embodiment of the weightless scale system;

FIG. 4 is a perspective view of an installation of the weightless scale system according to one embodiment;

FIG. 5 is a block diagram of the weightless scale system according to another embodiment;

FIG. 6 is a perspective exemplary view of a user in front of the display according to one embodiment;

FIG. 7 is a perspective illustration of the weightless scale system in an embodiment using two displays;

FIG. 8 shows an exemplary display screen for a user-inputted target weight for a differential weight measurement;

FIG. 9 shows a single-user display screen according to one embodiment;

FIG. 10 shows an exemplary set-or-change default settings display screen;

FIG. 11 shows alternate options for date selection;

FIG. 12 is an exemplary multiple user display screen;

FIG. 13 is an alternative exemplary multiple user access display screen;

FIG. 14 is a method flow diagram in one embodiment for setting up the weightless scale system;

FIG. 15 is a method flow diagram in one embodiment for use of the weightless scale system;

FIG. 16 is a block diagram according to one embodiment for a wireless network weightless scale system;

FIG. 17 is an illustration of a wireless network weightless scale system used in a Wi-Fi network; and

FIG. 18 is an illustration of a wireless network weightless scale system used with the Internet.

### DETAILED DESCRIPTION OF EMBODIMENTS

Descriptions are provided herein for embodiments based on the drawings. In the respective drawings, the same constituents are designated by the same reference numerals and duplicate explanation concerning the same constituents is omitted. All of the drawings are provided to illustrate the respective examples only.

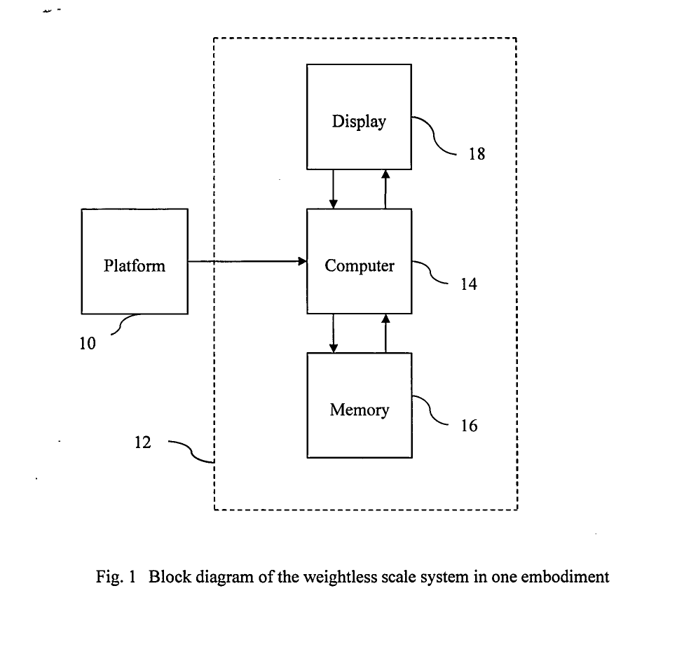

FIG. 1 is a block diagram of components of the weightless scale system according to one embodiment. A platform 10 is connected to a display assembly 12 which includes computer 14 that is connected in a bi-directional manner to a memory 16 and a display 18. The platform is the apparatus that a user steps on to activate the system and initiate the desired measurement. In one embodiment, platform 10 is in the form of a bathroom scale. Platform 10 could take the form of any other structure suitable for stepping onto to take a weighing.

Although measuring the user's weight is the most common measurement for a bathroom scale, the weightless scale of the disclosure is not limited to a weight measurement. While a functional description may be stated at times herein as being a weight measurement, it is understood that the function may not even be selected to include a weight measurement, but rather is one or more body composition measurements as selected by the user. Platform 10, as used herein, includes the weight measuring apparatus, power supply and output port as well as the platform that supports the user, and at times may be referred to as the scale, scale apparatus or scale weighing apparatus. The power supply for the scale could be by batteries in the scale, or can be supplied through the connection with computer 14, with power then being supplied to the platform from the computer. “Weightless scale system,” as used herein, refers to the weightless scale system of this disclosure and its various embodiments.

The weight measurement apparatus and the automatic activation of the weightless scale system by use of an On-Off sensor are built into the platform and, being known in the art, they are not described in detail here.

Computer 14 is functionally connected to the scale apparatus to receive the data output from the scale weighing apparatus. In one embodiment, computer 14 is physically located in display assembly 12 as shown in FIG. 1, although computer 14 can be located elsewhere and not with display 18. For example, computer 14 can be located within the structure of platform 10. Also as one example of where a thin screen wall-mounted display 18 is used, computer 14 and memory 16 can be located separately from both platform 10 and display 18. Beyond the conventional type of computer as is known, computer 14 could be a laptop computer or any suitable data processing circuitry or component, such as a microprocessor. Memory 16 can be the memory normally contained within a computer, in which case memory 16 is included within and as a part of computer 14 and would not be a separate component as is indicated in FIG. 1. Alternatively, memory 16 could be a separate memory module or component as shown in the embodiment of FIG. 1.

The connection between computer 14 and memory 16 is bi-directional with the memory used to store data and to provide stored data to the computer as needed. Access ports to the display and the computer, such as USB ports for a wired connection or a wireless access port for a wireless connection, are provided on display 18 as needed for connecting display 18 to computer 14. One or more USB ports are provided on display 18 for the option of connecting a keyboard and/or a mouse to display 18, which in turn are operationally connected to computer 14. Alternatively, the computer's USB ports can be used for the optional attachments of a mouse and keyboard.

Display 18 is connected to computer 14 to receive processed data from the computer and display information on a display screen which is included as part of the display. The display screen could be any of the various known types of display screens. For example, the display screen could contain a digital alpha-numeric segmented light emitting diode (LED) display, as is known, where the segments switch on and off to give the appearance of a desired alpha-numeric character or a glyph. A liquid crystal display (LCD) or thin film transistor LCD (TFT-LCD) display, a LED display, a plasma display, and a resistive or capacitive touch screen display, are some other exemplary display types useable in the weightless scale system. Display 18 can contain one or more types of different screen displays. For example, a segmented numeral bit segment display can be used for displaying measurement readings and a touch screen display can be used for making selections in use of the weightless scale system.

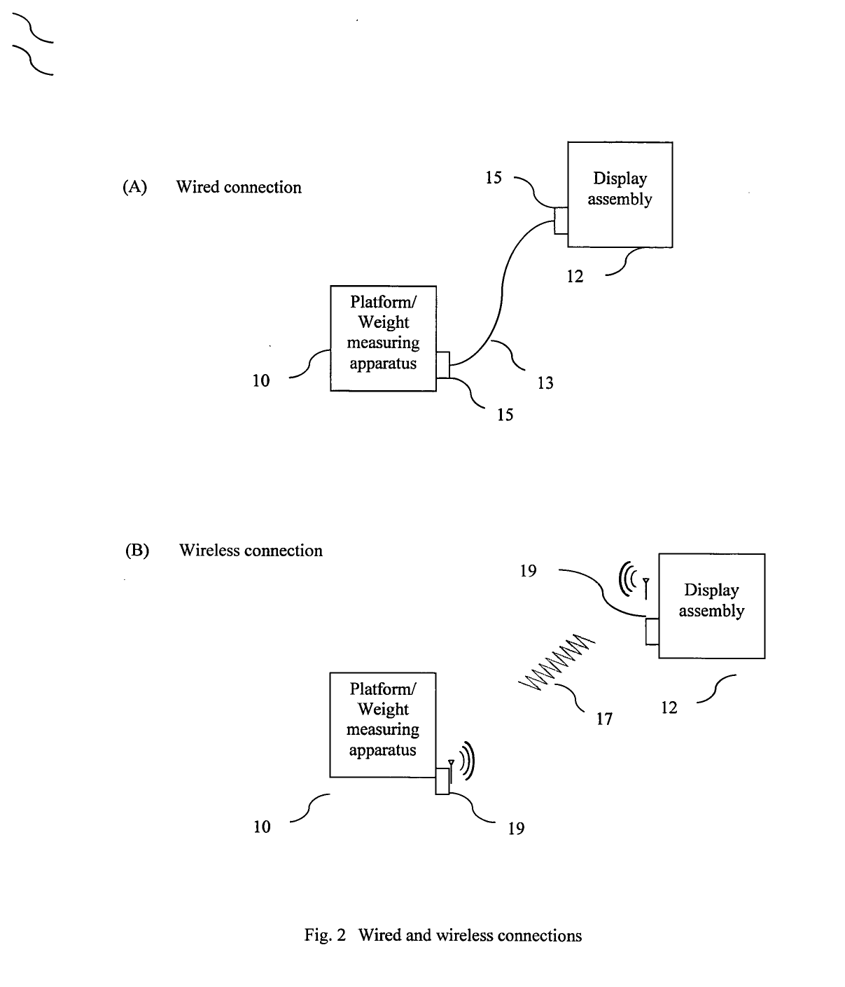

Platform 10 and display assembly 12 can be connected by a wired connection, as shown in FIG. 2(A), or by a wireless connection, as shown in FIG. 2(B). In the wired connection of FIG. 2(A), platform or weight measuring apparatus 10 is connected to display assembly 12 by a cable or other wired transmission path 13 connected to access ports 15, such as a USB port, on both weight measuring apparatus 10 and display assembly 12. In the wireless connection of FIG. 2(B), platform or weight measuring apparatus 10 is connected to display assembly 12 by a wireless signal 17, such as a radio frequency (RF) signal, although other types of wireless signals, such as an optical communication link, could be used. An appropriate radiating and receiving transmission device is attached to both weight measuring apparatus 10 and display assembly 12. In the wireless embodiment of FIG. 2(B) using RF as the transmission signal, each access port 19 includes an antenna system for the RF signal.

The wired connection 13 or the wireless connection 17 in a preferred embodiment is unidirectional with the weight measuring apparatus signal sent to display assembly 12 for signal processing, signal storage and display; however, the connection could be bidirectional, such as in an alternative embodiment where a microprocessor, a computer, or other signal processing component is included in weight measuring apparatus 10. In that case processed signals are sent to the display assembly and display assembly 12 includes display and body composition measurement control selections that are sent from display assembly 12 to the microprocessor or other signal processing component in the weight measuring apparatus. A still further embodiment has a computer, microprocessor or other signal processing and memory storage components in both platform 10 and display assembly 12 for carrying out the functional operation of the weightless scale system.

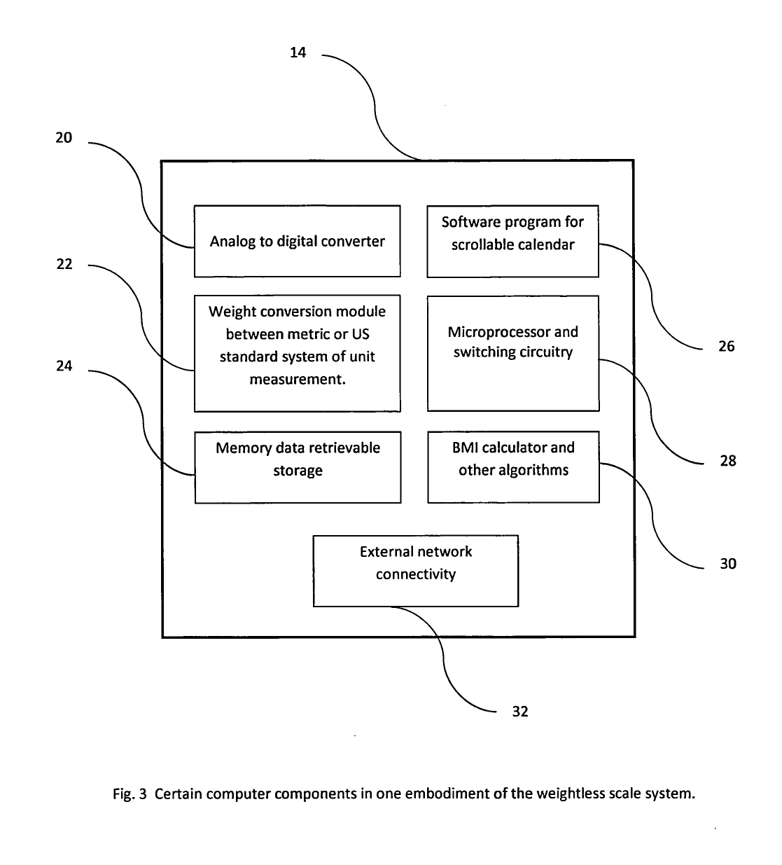

FIG. 3 is a block diagram showing some components of computer 14 used in an embodiment of the weightless scale system. Analog to digital converter 20 converts the scale reading mechanism of platform 10 to a digital signal. This component can be in computer 14 or in platform 10. Weight conversion module 22 converts the unit measurement or measurements to be displayed on display 18 to the US standard system or to the metric system, according to the user's preference. Although these are the only two selectable units of measurements available in a preferred embodiment, it is understood that other units of measurement conversions can be included as well. A reference to various other units of measurements possible is as listed in the International system of Units (SI) maintained by the International Bureau of Weights and Measures (BIPM, for Bureau International des Poids et Mesures) in Paris, France.

Memory data retrievable storage 24 is memory either in the computer or external to the computer, or a combination of both internal and external memory, for storing and retrieving data. Software program for scrollable calendar 26 is software that projects a calendar onto the display screen of display 18 and enables the calendar to be scrolled from the present day back to any day, month, and year. This software also allows a user to select a date as the benchmark or reference date from which a current measurement is measured against for the purpose of displaying a differential measurement. Scrollable calendar software 26 also enables the user to select two dates to identify a range of calendar dates for a date range or data bracket over which a measurement and differential output reading is made.

Microprocessor and switching circuitry 28 represents a microprocessor within the computer, or a computer signal processing functional component other than a microprocessor, for receiving, processing, storing and outputting data according to formats and selections made in using the weightless scale. Microprocessor and switching circuitry 28 also includes the appropriate software for executing the signal processing and for controlling logic circuits for managing user measurement selections and display options of the weightless scale as selected by the weightless scale's one or more users.

BMI (body mass index) calculator and other algorithms 30 represents one or more other data processing modules for carrying out specific measurements and displays and contains the signal processing functionality associated with other of the measurement and connectivity capabilities of the weightless scale according to various other embodiments. The use of this component depends on what body composition measurements are selected by a user to be made. If, for example, a BMI measurement is not required in the one or more body composition factor measurement selected by a user, the BMI calculator component of BMI calculator and other algorithms 30 would not be used. Likewise, if a body temperature was not selected as a measurement to be made, the associated body temperature circuitry and software component in BMI calculator and other algorithms module 30 would not be used. Computer 14 also includes external network connectivity module 32 that contains software and circuitry for wired or wireless connections for the weightless scale system to transmit and receive information to and from other networks and/or other computers. The functional details of the individual computer components presented in FIG. 3 are known and hence those details are not presented here, other than further description of some algorithms presented later herein.

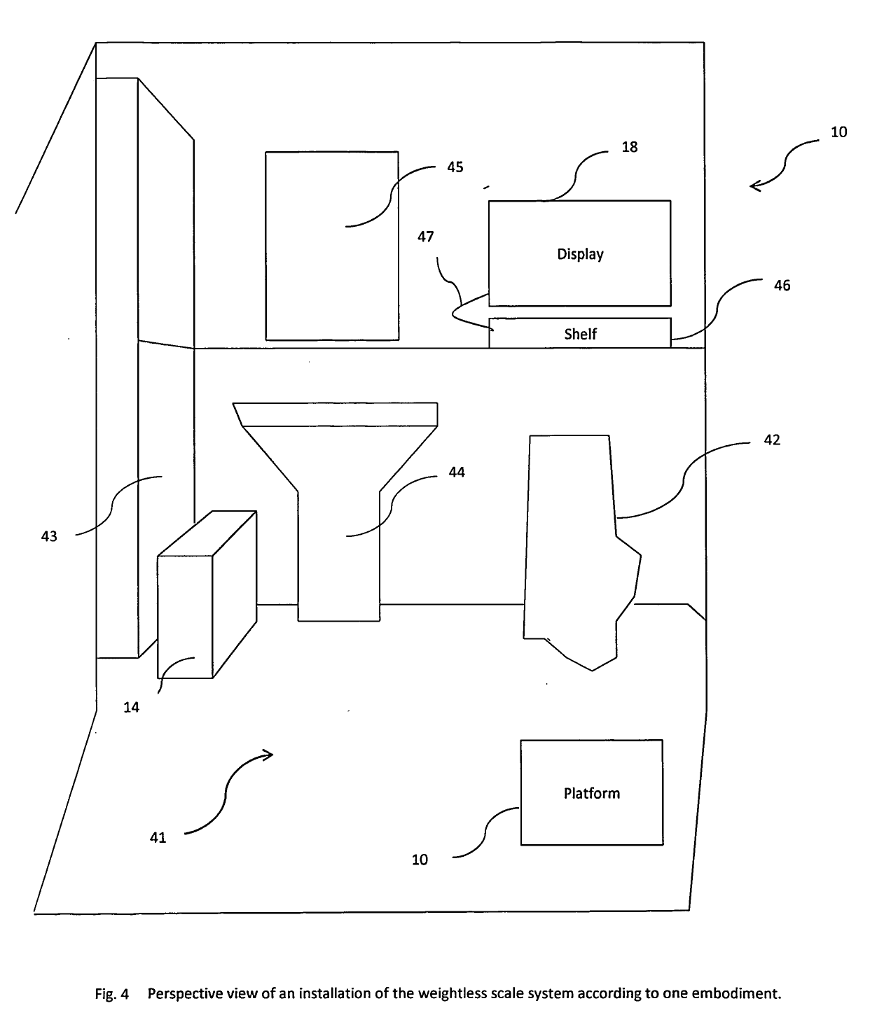

FIG. 4 is a perspective illustration of a bathroom installation for use of the weightless scale according to one embodiment. In the embodiment of FIG. 4, the platform 10, computer 14 and display 18 components are separate from each other and operationally connected (not shown), with platform 10 placed on the floor 41 of the bathroom in front of the toilet 42.

Platform 10 is movable from a stored location to the illustrated position in front of toilet 42. Computer 14 is in an out of the way area, such as up against a wall 43 under the bathroom sink 44, shown with a bathroom wall mirror 45 above bathroom sink 44. Display 18 is wall mounted so that it faces toward, and is readable by, the user when the user stands on platform 10. In one embodiment, a shelf 46 can be placed below display 18 extending outward from the wall for placing a keyboard and mouse that are connected by a cable 47, or are connected wirelessly, to inputs, such as USB ports, on display 18. This is only an option and is not necessary for use of the weightless scale in the embodiment of FIG. 4. Variations in the illustrated arrangement are, for example, that the computer be located in another room and that it be connected wired or wirelessly with platform 10 and display 18, and that a keyboard and mouse, for setting up the default settings for the weightless scale and for changing those settings and making other measurement selections, be connectable directly to the USB ports on the computer. The computer could be a laptop rather than a PC, or any other type computing device, such as a handheld device.

In use, the user stands on platform 10 and reads the selected measurement from display 18. Although display 18 is wall mounted in FIG. 4, it can be appreciated that the display does not need to be wall mounted, but could be located on, and as a part of, platform 10 which, of course, would have a size large enough to accommodate the user standing on the platform and also accommodate the display with a size large enough to be readable by the user in the standing position. Alternatively, display 10 is mounted at the top of a pedestal extending upwards from the platform which would make the display closer to the eyes of the user.

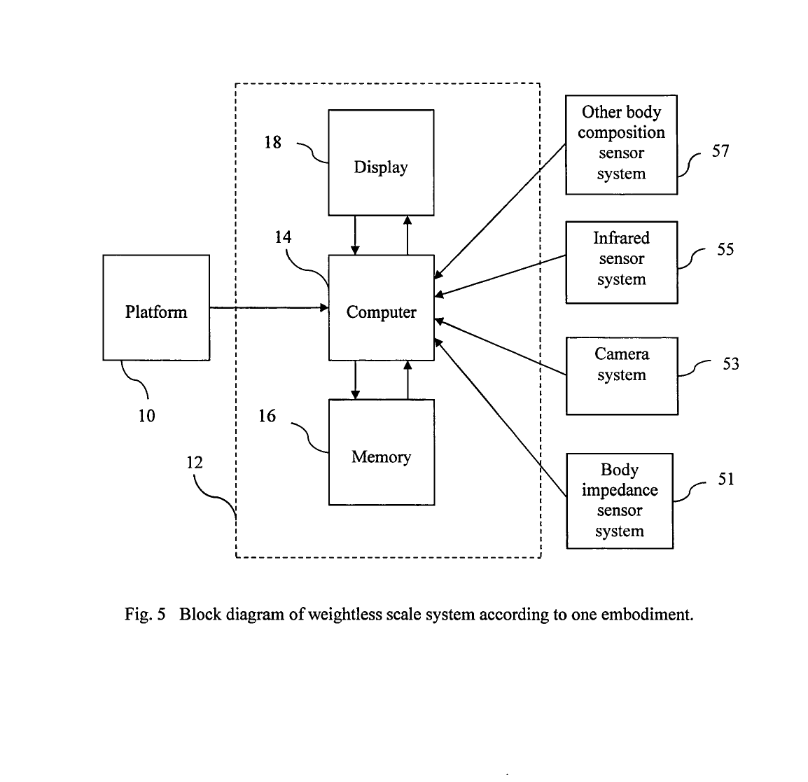

FIG. 5 is a block diagram of the weightless scale system according to one embodiment. In the embodiment of FIG. 5, the weightless scale system includes added measurement functionality that goes beyond the weight measurement. In FIG. 5, platform 10 and display assembly 12 are as previously explained and so this part of FIG. 5 is not repeated again here.

Additional weightless scale functionalities are shown by the block diagrams on the right side of FIG. 5. Body impedance sensor system 51 represents the mechanism and signal processing system for measuring body impedance. Body impedance is used in measuring the body mass index. This can be performed for an entire body or for a particular body part by focusing the body impedance sensor on that particular body part, such as the right forearm or left bicep. Camera system 53 is a photographic system for taking a picture of the user. In a preferred embodiment, camera system 53 has a variable lens system that has more than one preset lens position, such as to take a shoulder-level picture, as a passport type of picture, or a full height picture of the user, which would be a picture that encompasses at least from the feet to the head of the user. The user can select the option of whether or not to take a picture, that is, whether or not camera system 53 is to be activated in a particular use of the weightless scale system. If camera system 53 is activated, the user can also select the scope of the picture, such as a shoulder-level picture or a full height picture. In addition to the two basic options as to picture scope of a preferred embodiment, any view as to the scope of the picture taking capability can be preset in the camera system and made as one of the selectable features in use of the weightless scale system.

Infrared sensor system 55 makes use of infrared technology in measuring a body composition factor, such as a body temperature. Other body composition sensor system 57 represents a system for making other body composition measurements where a particular body composition measurement can be made from a remote sensor in the physical arrangement of the weightless scale system, i.e., with the user standing in front of the sensor, one example of which is that shown in FIG. 4, and where the user desires to include such a measurement in its use of the weightless scale system.

As indicated in FIG. 5, the signal output of each component, 51, 53, 55 and 57 is operationally connected to computer 14. Details as regards the operation of each of systems 51, 53 and 55 are known. Other body composition sensor 57 provides for incorporation into the weightless scale system of any other known technology beyond those identified in FIG. 5 for measuring a body composition factor. Hence further operational details of systems 51, 53, 55 and 57 are not provided here.

### Algorithms

The weightless scale system's use of selections of one of more of the desired body composition measurements, and selections of one or more desired displays and measurement results, uses logic and switching circuits as known and those circuit details are not further described herein.

Calculation of a body mass index (BMI) applies a known method of bioelectrical impedance analysis where the scale sends an electrical current (harmless) up through the body to “read” the amount of fat body mass and lean body mass. Calculation of certain of the identified body composition factors uses known bioelectrical impedance analysis where the scale sends such an electrical current to “read” the amount of fat body mass and lean body mass. Current passes more slowly through fat than muscle, and this is used to give a measurement of how much fat is in your body compared to muscle, or body fat %. Based on this variable impedance factor, the percentage of body fat can be calculated.

To assess body fat content, a user enters its user profile (height, age and gender). From the user's measured weight with the user profile information, it is known that a user's body composition factors such as body fat (total and segmental), body water %, muscle mass (total and segmented) can be calculated. Although for clarity age and gender input boxes are not shown in the exemplary displays, provision for these data inputs can be included in the weightless scale system.

BMI is calculated as weight divided by the square of height. The following equation (1) gives this for a reading in the metric system and equation (2) gives a reading in the U.S. system:

$$\begin{matrix}BMI = \frac{mass ( kg )}{{( height ( m ) )}^{2}} & ( 1 ) \\ BMI = \frac{mass ( lb ) \times 703}{{( height ( in ) )}^{2}} & ( 2 )\end{matrix}$$

A BMI reading will vary depending on the amount of fluid in the body, and hence a “% water” measurement may also be desired although it is not essential.

Height and weight data are inputted into a BMI calculator, included in body impedance sensor system 51, to determine an overweight, underweight or normal weight status. While this height and weight data alone do not address percentage of body fat or muscle, they do give one measure of a health evaluation linked to weight. Although not shown on the exemplary display screens in the figures, a height measurement can be made, such as by being included in other body composition sensor system 57, and an appropriate display box can be included in display 18 to present this information to the user and have this added to the results stored in memory 16 of the weightless scale system.

The harmless current for the BMI measurement can be injected into a body by other known methods than from the feet of a user touching platform 10 of the weightless scale system, and such other known methods are useable with the weightless scale system as well and can be incorporated in the measurement apparatus and display screens of the weightless scale system.

Use of infrared technology is another method for measurement of certain body composition factors. In infrared technology, a beam of infrared light is transmitted into the body where the light is reflected from the underlying muscle and is absorbed by the fat. Alternatively this same method can be focused on a particular body part, such as a thigh for example, to obtain body composition factor measurements for that particular body part. The use of infrared interactance to measure body composition factors is known. See, for example, Joan M. Conway, PhD, Karl H. Norris, B S, and C. E. Bodwell, PhD, American Journal of Clinical Nutrition, December 1984, pp 1123-1130, incorporated herein by reference. See, e.g., “Omegascope” infrared thermometer series, manufactured by Omega Engineering, Inc., Stamford, Conn.

Photographic, laser or infrared technology can be used to measure the user's height using known geometric or trigonometric methods. As one example, the source sensor determines the line of sight to the top of the user as “D” (distance), determines the line of sight to the ground or feet of the user, and designates the angle between the two lines as theta. The distance of both lines is calculated. The height of the user is D*tan(theta), where “*” indicates multiplication and “tan” is the tangent of angle theta. This or an equivalent known algorithm for measuring height is used in the weightless scale system for making this body composition factor measurement.

### Differential Measurement Algorithm

The weightless scale system includes an algorithm that provides a determination of weight changes over meaningful time periods that has heretofore not been provided in differential weight measurement systems. First, the scale system of the disclosure includes a calendar program whereby the user can select any year, month and day since the scale system was first used as the differential benchmark date. Secondly, the scale system of the disclosure provides the following addition specific selections for any selected body composition differential measurement.

1. Weekly algorithm.
(a) Weekly weight change=weight (today) minus (−) weight (today)−7 days.
(b) If (a) shows no weight stored in memory on that day, i.e. on the 7^{th} day prior to the current use of the scale system, then the algorithm goes to one day later: weight change=weight (today)−weight (today−8 days}.
(c) If (b) shows no weight stored in memory 8 days earlier, the algorithm goes to one day earlier: weight change=weight (today)−weight (today−6 days).
(d) If (c) shows no weight stored in memory 6 days earlier, the algorithm goes to two days later: weight change=weight (today)−weight (today−9 days).
(e) If (d) shows no weight stored in memory 9 days earlier, the algorithm goes to two days earlier: weight change=weight (today)−weight (today−5 days).
(f) If (e) shows no weight stored in memory 5 days earlier, the scale system reports a “not available” on the display screen.

2. Monthly Algorithm.
(a) Monthly weight change=weight (today)−weight (today−30 days).
(b) If (a) shows no weight stored in memory on that day, i.e. on the 30^{th} day prior to the current use of the scale system, then the algorithm goes to one day later: weight change=weight (today)−weight (today−31 days).
(c) If (b) shows no weight change stored in memory 31 days earlier, the algorithm goes to one day earlier: weight change=weight (today)−weight (today−29 days).
(d) If (c) shows no weight stored in memory 29 days earlier, the algorithm goes to two days later: weight change=weight (today)−weight (today−32 days).
(e) If (d) shows no weight stored in memory 32 days earlier, the algorithm goes to three days earlier: weight change=weight (today)−weight (today−28 days).
(f) If (e) shows no weight stored in memory 28 days earlier, the algorithm goes to three days later: weight change=weight (today)−weight (today−33 days).
(g) If (f) shows no weight stored in memory 33 days earlier, the algorithm goes to four days later: weight change=weight (today)−weight (today−27 days).
(h) If (g) shows no weight stored in memory 27 days earlier, the scale system reports a “not available” on the display screen.

3. Overall Algorithm.
Overall change=weight (today)−weight (benchmark). This is for the situation where the user has entered a benchmark earlier date for the differential measurement. A separate benchmark date can be entered for each user.

In the above described cycle of the algorithm, the date the algorithm finds as having a stored measurement can be selected to be displayed with the differential measurement to show the user the date from which the differential measurement is calculated.

The differential measurement can be made for any body composition factor measurement and is not limited to just a weight measurement.

4. Multiple Measurement on a Same Earlier Day

In the event that a user makes multiple measurement on a same earlier day, the default mode of the algorithm is that it selects the last measurement made for the designated user on that day. This is helpful, for example, if by mistake someone else recorded their weight over the user's weight, the user can make their selected body composition factor measurement again. That last measurement will be selected by the algorithm and hence it protects against a mistake being made earlier on that same day.

Thus, it is seen that the algorithm used in the weightless scale system for calculating the differential measurement of a selected body composition factor subtracts the reference or benchmark measurement from the current measurement. The result is preceded with a plus sign (+) if the current measurement is larger than the benchmark reference and with a minus sign (−) and if the current measurement is smaller than the benchmark reference.

It is further seen that if a measurement does not exist for the date selected, the algorithm first looks to one day closer to the current date for a stored measurement and uses that measurement as the benchmark date, and displays that new date on a display screen so to inform the user that no measurement was made on the selected date and the differential reading is made based on the displayed date on which a stored measurement was found. In the event that no measured result exists on the one day closer to the current date, the algorithm functions to conduct a search of the one day in the opposite direction, that is, one day further back from the selected date, in the direction further back from the current date and determines whether a measurement is stored for that date. This process is repeated, with the search advancing one day more in each direction until a stored measurement if found. That date is then displayed with the differential measurement result to inform the user of the closest date found on which a prior measurement was made for the selected body composition factor.

In one embodiment, the algorithm, when the differential benchmark is set for one week earlier, looks back for two days in either direction in the process explained, and if no measurement if found for two days in either direction, the search terminates and notification is made on the display that no measurement is available on the selected date including + or − two days in either direction from that date. The user then has to enter a different benchmark date. When the benchmark date is set for one month earlier, the same procedure is followed except in a preferred embodiment, the algorithm searches for three days in either direction.

While the above is the process of the algorithm as applied in a preferred embodiment, it is not limited to this process. For example, the algorithm can be such that the search continues with the same alternating date directions, and continues to advance one day at a time until it reaches a date on which a measured result for the particular selected body composition factor exists. That date is then displayed to inform the user of the closest benchmark date found and the result is displayed based on that found closest benchmark date.

Embodiments for Use with One and Two Displays

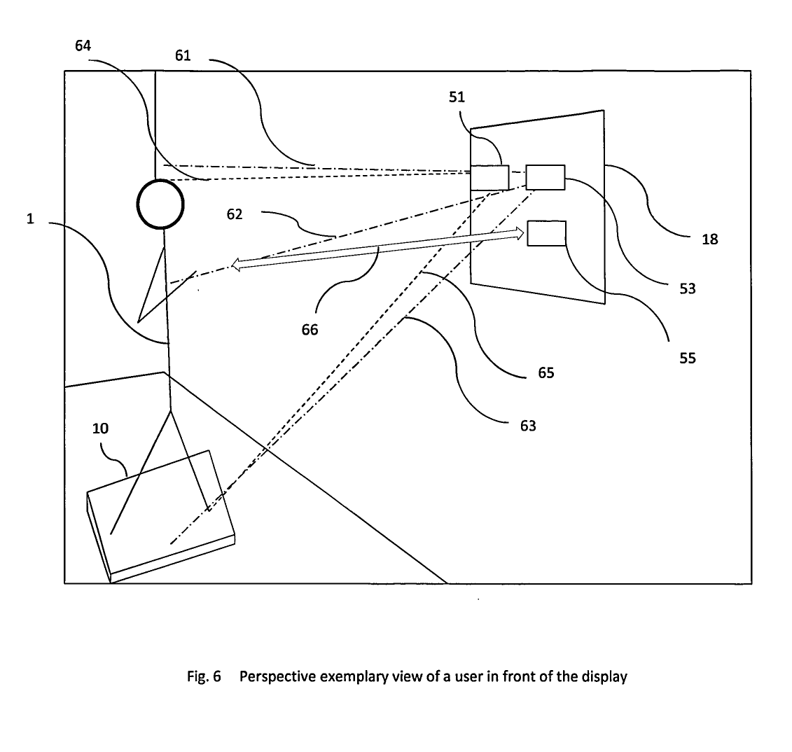

FIG. 6 is a perspective view to illustrate the use of the weightless scale system of FIG. 5 according to one embodiment. In FIG. 6, a user 1 stands on platform 10 in front of a wall mounted display 18. Display 18 includes a display screen viewable by user 1. The computer is placed elsewhere and is operationally connected to display 18. In another embodiment, display 18 could be a component of the display assembly 12 (FIG. 5) with display assembly 12 mounted in one structure on the wall where display 18 is shown in FIG. 6.

In the embodiment of FIG. 6, three body composition sensors are illustrated as examples for describing the use of such other body composition measurement systems as part of the weightless scale system. The body composition sensor systems, being body impedance sensor system 51, camera system 53 and infrared sensor system 55 are housed within display 18 as part of the display structure. Alternatively, only the sensor and lens mechanisms can be included in display 18, and the rest of each respective body composition measurement system can be located elsewhere, with the respective parts of each body composition measurement system connected by a wired or wireless communication link to its respective sensors.

For example, in one embodiment, camera system 53 is completely housed within display 18, and the data representing the picture taken is transmitted to computer 14 in which a camera software program has been downloaded for processing the camera's data. Body impedance sensor system 51 could have just the sensor mechanism located in display 18 and the data from that sensor transmitted to a body impedance sensor module located elsewhere for processing the sensor data, and have that body impedance sensor module connected to the computer. In another embodiment, the body impedance sensor system has its system integrated within the computer so that data from the body impedance sensor in display 10 is transmitted to computer 14 where the data is processed for calculating and displaying an associated measurement. The same type of various alternatives are applicable as well to infrared sensor system 55 and other body composition sensor system 57 (not included in FIG. 6).

FIG. 6 illustrates how the body composition measurements are made of user 1 standing on platform 10 in front of display 18. For example, the lens of camera system 53 can be visually focused in height from line 61 to line 62, shown as lines in a dash-dot-dash format, to take a shoulder level picture of user 1. The lens of camera system 53 can alternatively be focused in height from line 61 to line 63 to take a full height picture of user 1, with line 63 also being in the dash-dot-dash format to indicate a camera system line.

Body impedance sensor system 51 measures body impedance of the full body of the user, as indicated by dashed lines 64 and 65. Although not illustrated to maintain clarity, body impedance sensor system 51 can be focused on a particular body part, such as a right forearm or left bicep, rather than the full body, to obtain data for calculating a measurement on that particular body part alone. Body impedance measurements are used in the calculation of body composition factors such as body fat, muscle mass and % water. Infrared sensor system 55 is focused on user 1, as indicated by the arrowed line 66, also to obtain body composition measurements, such as body temperature.

There are several embodiments for the use of the weightless scale system as regards the illustration of FIG. 6. In one embodiment, display 18 is mounted with computer 14 and memory 16 in one wall structure. In another embodiment, display 18 only is wall mounted and computer 14 and memory 16 are located elsewhere and operationally connected to display 18. In the embodiment of FIG. 6, at least the sensor component of one or more body composition factor measurement systems, such as body impedance sensor system 51, camera system 53, infrared sensor system 55 and optionally other body composition sensor system 57, are mounted in, and as a part of, display 18 and directed towards the standing position of user 1. In an alternative embodiment using two displays, the display readout measurement data could be located on a top display platform on a vertically extending pedestal connected to and projected upwardly from platform 10. This embodiment puts the measurement readings closer to the user for easier viewing. While the sensor systems are illustrated in FIG. 6 as being wall mounted, except for the weight measurement apparatus which is a part of platform 10, they could alternatively be positioned on a similar upright structure other than a wall. Other user selectable settings and controls for the weightless scale system could be incorporated in display 18 or could be located on a separate second display panel.

### Exemplary Displays

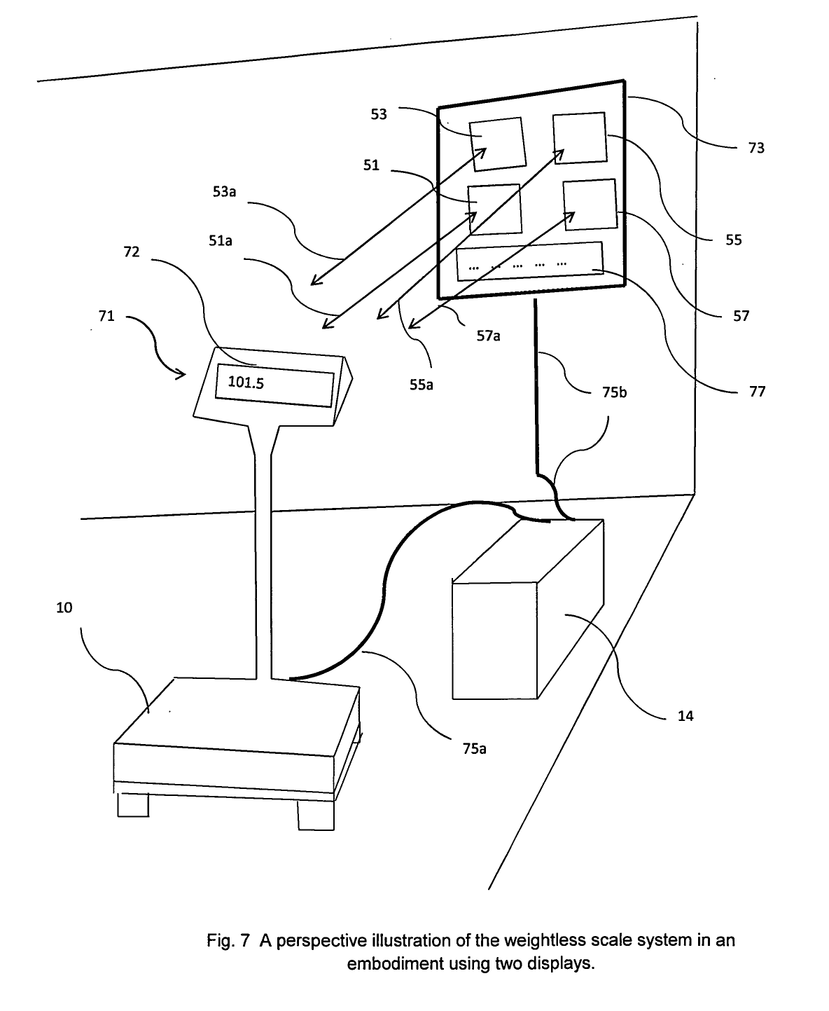

FIG. 7 is a perspective illustration of an alternative embodiment that uses a pedestal measurement reading display structure 71 formed as an upward extension from platform 10. The top portion of the measurement reading display structure contains as a first display 72, having one or more numeric readouts. Just as one example of a type of numeric display that could be used, first display 72 uses a seven segment bit numeric display with a four numeric display capability and a decimal point between a first and second of the four numbers.

Body measurement sensor systems 51, 53, 55 and 57 are wall mounted on a second display 73 that faces pedestal measurement reading display structure 71. Computer 14 is located elsewhere, with it being on the floor in FIG. 7 for an illustrative purpose in showing the computer component of the weightless scale system. The computer is operatively connected to platform 10, first display 72 and second display 73 by wired connections 75a and 75b in FIG. 7. Arrowed lines 51a, 53a, 55a and 57a indicate the paths of bidirectional signals, at least one signal being sent from each sensor system which the user has selected to be activated, towards the user, and at least one signal being received at the respective body composition sensor system as a returning signal from the body, or from a particular portion of the body, of the user. Second display 73 also contains other selection controls, indicators and the like 77 associated with the weightless scale system.

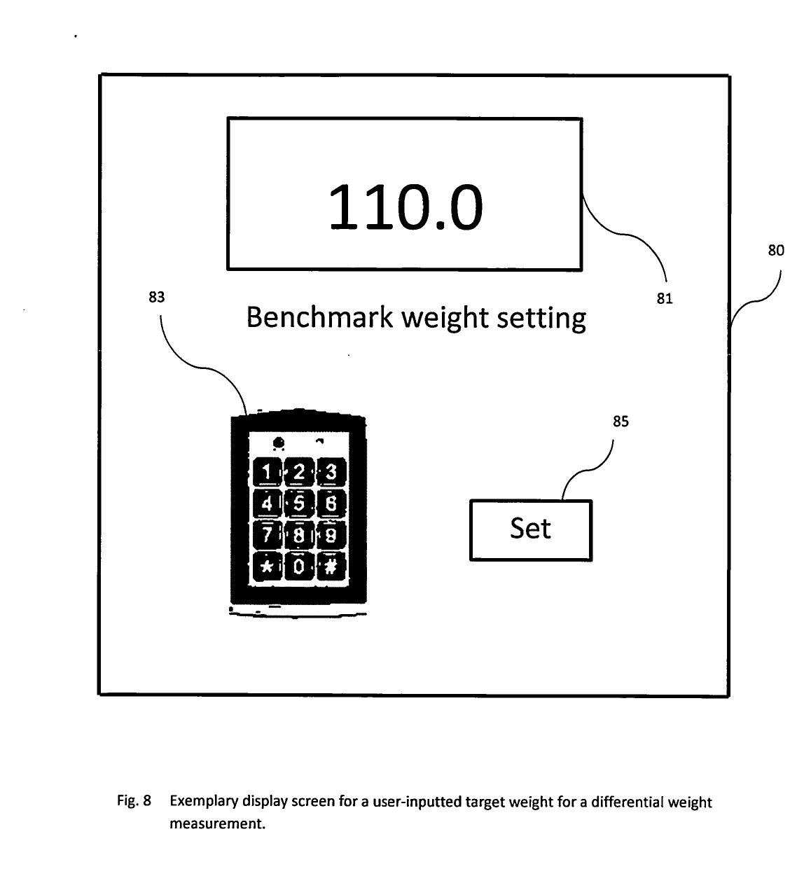

FIG. 8 is an exemplary display screen 80 for a user-inputted target weight as the benchmark for a differential weight display. In addition to measuring and displaying a differential weight that is referenced back to a prior weight reading from an earlier date as selected by the user, the weightless scale system in another embodiment can reference a current weight reading to a desired weight goal by the user inputting a “target goal” number, as a target weight, using a keypad on the display. The user first selects “target goal” on a first display screen. This causes a second display screen, such as that shown in FIG. 8, to appear on the display, such as display 18 in FIGS. 4-6 or display 72 in FIG. 7. The user enters its target weight goal in numeric display 81 using keypad 83, then presses “Set” button 85 to enter the inputted weight number as the reference against which future weight measurements are to be measured against. This “target goal” function is operative only when the user selected mode for a differential measurement display is activated. When “differential weight” is selected and the “target goal” function is used, only the difference between the two numbers, that is, the difference between the inputted target weight and the actual weight, is displayed.

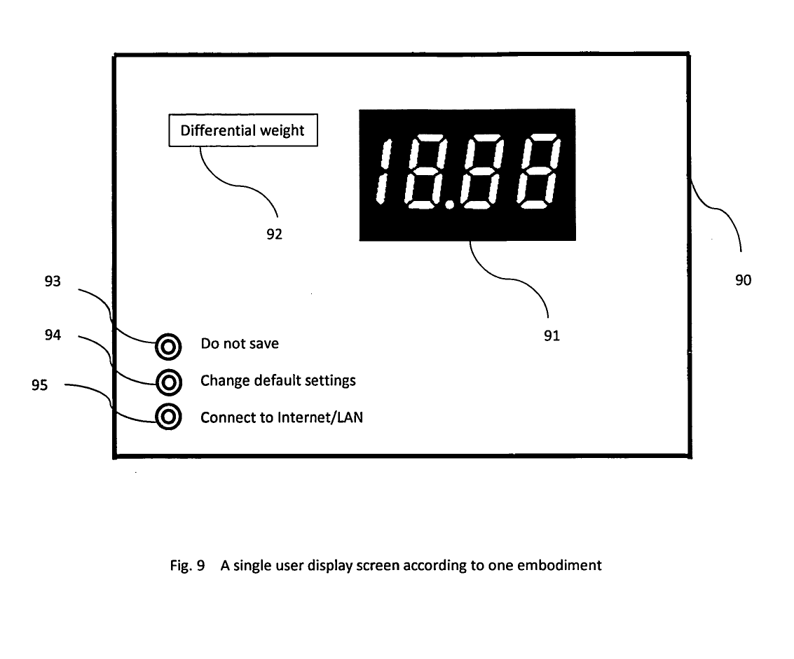

FIG. 9 is an illustration of a single user display screen 90 according to one embodiment for reading the measurements of the weightless scale system. This, for example, is one type of layout of a display screen as part of display 18 in FIGS. 4-6 or display 72 in FIG. 7. The weightless scale's measurement is displayed on a numeric digital display 91, which in one embodiment is a row of 7-bit segment digital displays. Although digital display 91 is shown as a four digit display with a decimal point in the center between two digits on either side, this is for illustrative purposes only and the numbers shown in FIG. 9 do not represent an actual scale measurement. A preferred display 91 is a 4 digit display with a single digit to the right of a decimal point. Any other type of display could be used, such as an LCD, LED or plasma numeric display or the use of projected images, as examples. Even an analog or mechanical display mechanism could be used.

To the left of numeric digital display 91 is an identifier 92 of the measurement displayed. In the exemplary display of FIG. 9, the weightless scale is set to show the differential weight and identifier 92 indicates this as the measurement being displayed. If a different measurement was displayed, identifier 92 would list the appropriate title, such as “actual weight,” or “body mass,” etc. In one embodiment, display screen 90 has one identifier 92 box and the appropriate title for the measurement is displayed in that one box. Alternatively, a list of multiple possible measurements are designed into the screen using multiple identifier boxes, with only the one associated with the number displayed being highlighted and the other boxes keeping a grayed out appearance unless or until they are activated.

Also, in another embodiment, display screen 90 is a touch screen whereby selections are made by touching specific parts of the screen which operates as a switch to a particular selection. For example, the weightless scale system has been set up to perform four measurements each time the scale is used: differential weight, body temperature, differential muscle mass and % water. The user steps on platform 10 which automatically activates the system, and the first body composition factor reading of differential weight appears in digital display 91 and its identifier 92 shows “differential weight” as the measurement being displayed. The user then taps on or touches the identifier 92 box which advances to the next of the four measurements performed, namely that of body temperature. The body temperature measurement appears in digital display 91 and identifier 92 reads “body temperature” to identify the number being displayed. Continuing to touch the identifier 92 box advances the displayed information in the same manner through the third and fourth measurements performed. The user then steps off platform 10 which automatically stores the four measurements just made in memory 16 and shuts off the weightless scale system.

Below digital display 91 and identifier 92 are three quick options for the user, this being as opposed to more detailed options that involve opening a default setting screen and going through a more extended process. The three options on display screen 90 are a Do not save button 93, a Change default settings button 94 and a Connect to Internet/LAN button 95. Each button, and its title included as part of the button, are grayed out unless activated by being touched on the preferred touch screen of display screen 90. Mechanical switches and remote control switches could alternatively be used in place of touch screen buttons 93, 94 and 95.

“Do not save button” 93 allows the user not to save this particular reading in the weightless scale's memory. If Do-not-save button 93 is not pressed then by default, the reading is saved in memory. Do not save button 93 becomes highlighted when touched to indicate that it is activated. With button 93 activated, when the user completes the measurements process and steps off platform 10, none of the measurements performed in that use of the weightless scale is saved in memory.

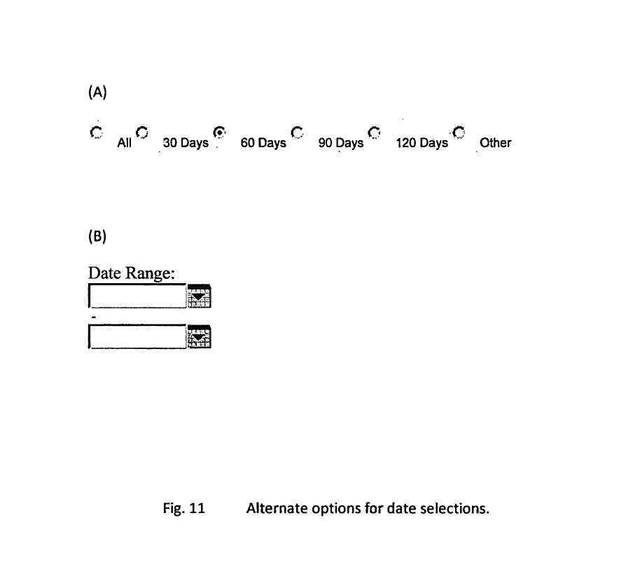

Change default settings button 94 allows the user to change the scale's default settings. If Change default settings button 94 is pressed, then a default settings screen appears, such as that shown in FIG. 11, and the user can re-set any one or more of the default settings according to its preference. Upon concluding the re-setting of any one or more of the available default settings and closing that program, display 18 returns to display screen 90 and performs the selected one or more weightless scale measurements. For example, if the user wanted to change from the muscle mass measurement to the body fat measurement, it would do so using the default settings screen. The weightless scale would then perform four measurements: differential weight, body temperature, body fat and % water in this example.

Connect to Internet/LAN 95 button allows the user to connect the weightless scale system to the Internet or to a designed local area network (LAN). It is understood that LAN includes a wide area network (WLAN) or any other kind of network other than the Internet for communicating. If connect-to-Internet/LAN button 95 is not pressed, the weightless scale system is not connected to any external computer network.

With the weightless scale system connected to Internet/LAN, the current and stored information of the weightless scale system is available at a computer connected to the network by going to a predetermined address or clicking an appropriate icon on the computer. Communication of the weightless scale system information can then commence using computer 14 in the Internet or LAN to which it is connected. Alternatively, a connection to the Internet or to a LAN can be made on computer 14 itself. However having this option on display screen 90 provides a quicker and more convenient access without having to go through additional steps, such as entering security codes, etc.

It is understood that while buttons are shown beside each of the three options and the description given is that the user presses a button, the display is not so limited. For example, the title of each option can have the title as part of the touch pad switch as well so that touching the title will activate the switch associated with the particular title. Any other switching apparatus can be used as well, such as by a toggle switch or other electronic, mechanical or remote control.

The display could be made in a certain format. For example, the display can have digital displays built into the display screen for each of all the other available body factor measurements, and all selected factors will then be activated and displayed under the appropriate body factor title on its associated display each time a body composition factor measurement is made. In one embodiment, there is a different display format, has one numeric display on the screen, such as a seven segment digital number display, and the measurements are displayed with a predetermined time delay, such as a 3-second “hold time” for showing each measurement along with an illuminated title of the measurement, such as “differential weight.” The display then automatically advances to showing the next measurement reading in the same manner until all the default measurements have been displayed. Another display option is to have the weight measurement displayed and let the user control the switching to display the other measurements in time segments convenient for the user by the user activating a button or similar switch, or preferably by a touch using a touch screen display. This gives the user control of the time for switching to read the other measurements.

### The Default Setup

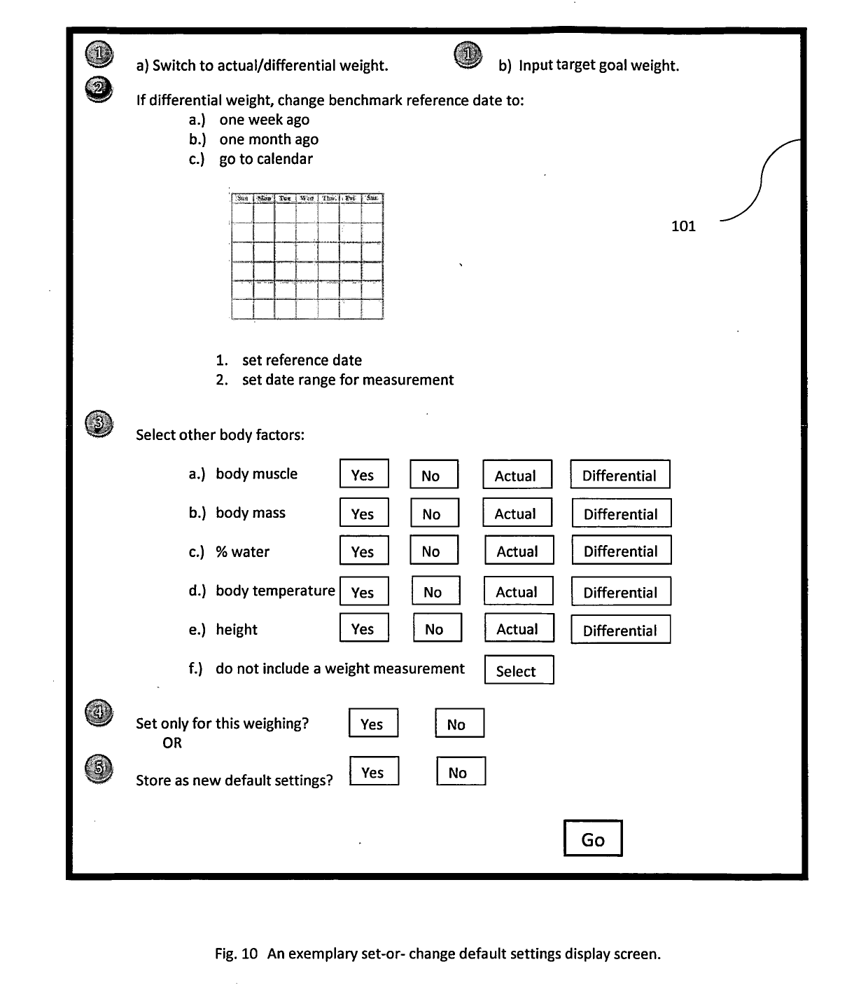

FIG. 10 shows an exemplary display for when Change-default-setting button 94 in FIG. 9 is pressed. Default setting screen 101 is used both for an initial setup of the weightless scale system and for later changing any of the settings from the initial setup. The layout of default setting screen 101 is exemplary only as a preferred display screen and can be changed in a variety of ways so to display and allow for the settings in different ways without departing from the scope of the disclosure. As in the previous displays of FIGS. 8-9, in one embodiment, default setting screen 101 incorporates a touch screen so that tapping or touching a particular portion of the screen will activate a switching of a particular display screen component.

Button 1 a) allows the user to select an actual or differential weight measurement. It is understood that in this description, the words “set” and “switch” are used interchangeably, with functions being set at an initial setup of the weightless scale system, and the functions being selectively switched in subsequent changes to the initial setup. As regards button 1, if for example the weightless scale is currently set to display the actual weight, pressing button 1, or pressing either button 1 or its title if together they are included as a touch screen switch will switch the weightless scale system to measure and display the differential weight. If the weightless scale is currently set to display the differential weight, pressing button 1 will switch it to measure and display the actual weight. Herein it is further understood that reference to switching a display includes switching the measurement performed that is associated with the particular display.

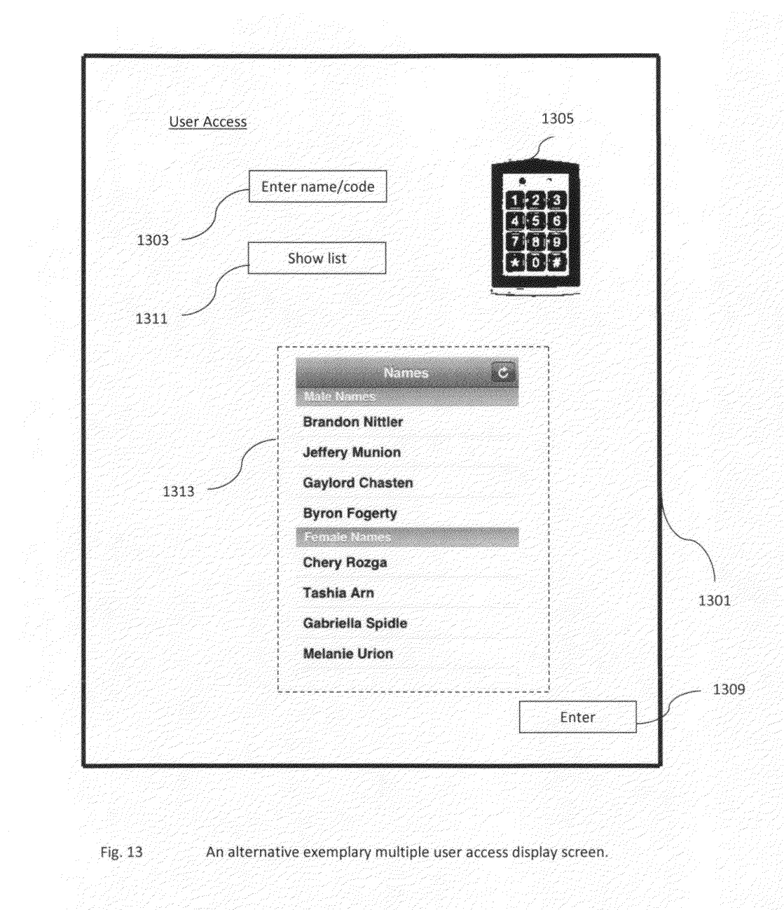

Button 1 b) allows the user to input or view an inputted benchmark weight, as discussed with regard to FIG. 8. Pressing button 1 b) brings benchmark display screen 80 up on display 18, which gives the user a convenient way to change the benchmark setting. With screen 80 displayed, keypad 83, is then linked to display box 81, and is used to change the benchmark number. Pressing the associated “Set” box stores the new benchmark number and disconnects the keypad from the benchmark number display for use elsewhere, such as in the multiple user display of FIG. 13.

Button 2 is selected if the user wants to change the benchmark or reference date from which a differential reading is measured. For example, if the weightless scale is currently set to display the differential weight referenced back to a weighing one week ago, and the user selects “one month ago,” whereupon the differential weight will be calculated as the difference between the current weight measurement and the weight measurement from one month ago as stored in the scale's memory, such as memory 16 in FIG. 1. The two selections listed of one week or one month ago are exemplary. Any other reference time period(s) can be included or added to that presented on default setting screen 101. Preferably the various options under button 2, as well as the options under the other buttons on default setting screen 101, are grayed out and the activated selection is highlighted to distinguish it from the other grayed out options when a particular selection is activated.

The third option c.) under button 2 is “go to calendar,” where the user can select any reference date from the calendar. The calendar is scrollable, so it can be scrolled back month by month, and even year by year. The user then highlights a date on the calendar month and year selected. As regards the use of the scrollable calendar, the user has the additional option of selecting one reference date, as indicated at 2 c.) 1, in which case future measurements are referenced back from the date of the current measurement to the selected reference date. The user also has the option of selecting a date range for the measurement, as indicated at 2 c.) 2, such as, for example, from Jun. 1, 2011 to Sep. 1, 2011.

For example, if at the end of the year, the user looks back and sees that she went through a particularly traumatic event during the year, such as the death of a close one followed by a period of great depression, she may want to see what impact, if any, it had on her health during that time. If that relevant time period was, as an example, from April 1^{st} to August 1^{st}, then she inputs those dates using the scrollable calendar and the display will show changes of the one or more selected body composition items for that time period. It will show the nature of any change (positive or negative) and the numeric amount just for that selected time period. As another example, this same capability might be desired for over the Thanksgiving and Christmas holidays, in which case she could select, for example, the time period from November 15 to December 28, and the differential numbers would be displayed for the selected item(s) for that time period.

If a date range is selected, then the weightless scale does not use the current measurement but instead, retrieves from memory the designated measurements from the two dates that make up the date range and displays that differential number, or numbers if more than one body composition measurement for a date range is performed. Although for illustrative purposes the scrollable calendar is shown in FIG. 10 as being associated only with the weight measurement, it is not so limited. In one embodiment, the scrollable calendar option is associated separately with each of the other body composition measurements so that a date range can be selected for any body composition measurement.

In an alternative embodiment of default setting screen 101, the scrollable calendar itself is not displayed. When the user presses go-to-calendar, this activates a switch that brings the calendar up on display 18 (FIGS. 1, 5) as a new calendar display screen (not shown), from which the desired benchmark date or date range can be designated on the calendar. When completed, the user presses a “set” or “go” button associated with the scrollable calendar which enters the date(s) selected and closes the calendar display screen and the user then continues with the selections on default setting screen 101.

In another alternative embodiment for both default setting screen 101 and the calendar display screen, the listing of a set-reference-date and set-date-range-for-measurement are not necessary. In this embodiment, the user selects either one or two dates on the scrollable calendar, then presses a “set” or “go” button, or the like, whereupon the selected date(s) is/are entered, stored in memory 16 and used in the selected measurements. If only one date is entered, the weightless scale system recognizes this is a benchmark date to use in displaying a differential reading, and if two dates are entered, the weightless scale system recognizes this is a date range to use in displaying a differential reading designated for one or more body composition factor. In this embodiment, the listing on default setting screen 101 or on the calendar display screen of “1. Set reference date” and “2. Set date range for measurement” are not necessary and are not included on the screen.

Button 3 in FIG. 10 allows the user to change the default setting for other body composition factors which are listed in the exemplary default setting screen of FIG. 10 as items 3 a.) through 3 e.) as body muscle, body mass, % water, body temperature and height. While body composition factors 3 a.) through 3 e.) are listed in the exemplary default setting screen in FIG. 10, the disclosure is not so limited to including all these body composition factors or to listing only these body composition factors. The weightless scale system can be set to measure additional factors, including body components, body status or body condition, that are measureable from a person being weighed on a scale or from a person standing in front of a sensor system display, such as display 18 in FIG. 6 or second display 73 in FIG. 7.

Under button 3, and assuming the preferred embodiment of a touch screen display is used in default setting screen 101, the user selects for each of body factor a.) through e.), “yes” or “no” as to whether to measure and display any of these body factors, and selects whether to display the measured one or more body factors as actual measurements, or differential measurements using the differential benchmark date, or date range, from the preceding button 2 on default setting screen 101. If, for example, in the embodiment where a calendar is associated with each body factor, another go-to-calendar touch switch box would be added associated with each listed body factor.

The described weightless scale system is contemplated as firstly providing a capability to measure and display weight, either as an actual or differential weight number, with an almost unlimited benchmark date being selectable for calculating the differential weight number, and adding to this weight capability other body composition factor measurements and similar displays as well. However, there are times when the weightless scale is used primarily to measure one or more body composition factors other than weight. For this reason, button 3 includes the option for the user not to include a weight measurement, as indicated at 3 f.) and its title. Pressing the associated Select box will direct the weightless scale system not to include weight in its measurements and displayed readings. If the Select box is not pressed, then by default, the designated weight reading type (actual or differential) is included in the measurements displayed.

Buttons 4 and 5 allow the user to designate whether the selected settings are to be used only for the current weighing, or are to be stored as new default settings. It is understood that although the phrase “for this weighing” is used for simplicity, the user does not need to select a weight reading at all since there may be use situations where weight is not the factor under study, as discussed.

Once selections on default setting screen 101 have been made, the user presses “Go” which activates the selections according to the user's designations, and concludes the change-of-settings procedure. The weightless scale system then performs the measurements, processes the data for display and for storage in memory. If do not save button 93 in FIG. 9 is presses, the measurement results of the current use of the scale are not stored in memory, but the new settings, if Yes in button 5 in FIG. 10 is pressed, are stored as the new default settings for the next and future use of the weightless scale system until the settings are again changed as described by use of the exemplary default setting screen of FIG. 10.

Other display options are available and usable in the weightless scale system for selecting the benchmark date and the date range for differential body composition factor measurements. FIG. 11 shows two such exemplary formats. In FIG. 11(A), the user selects from a list of available benchmark dates. If “Other” is selected, either a box in which to enter a date, or the scrollable calendar display, can be used to enter the “Other” date. In FIG. 11(B), the user enters a date range either by entering a date in the box or pressing the scrollable calendar arrow and selecting a date range from the calendar.

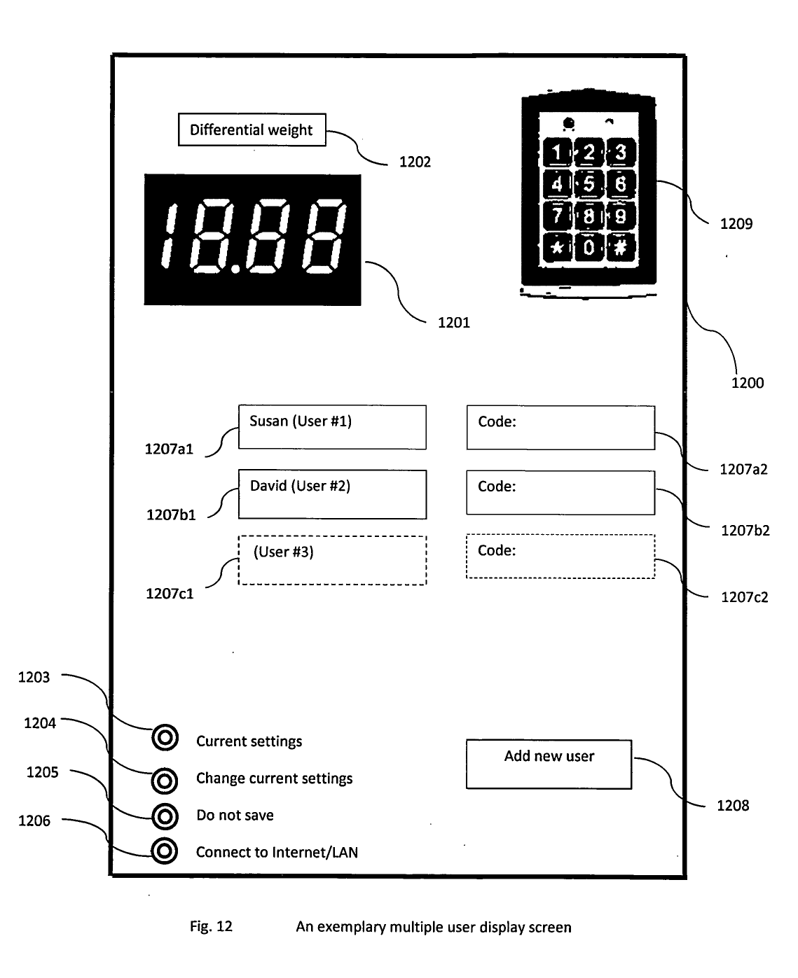

FIG. 12 is an exemplary multiple user display screen usable on display 18 of the weightless scale system and illustrates the scale's use with one or more users. Portions of multiple user display screen 1200 are the same as portions of display screen 90 in FIG. 9. These portions are display 1201 which is the same as component 91 in FIG. 9, Indicator 1202 which is the same as component 92 in FIG. 9, Change current settings button 1204 which is the same as component 94 in FIG. 9, Do not save button 1205 which is the same as component 93 in FIG. 9, and Connect to Internet/LAN button 1206 which is the same as component 95 in FIG. 9, and their descriptions and functions are not repeated again here.

Boxes 1207 are for entry of a user name and a user security code. The user names entered in FIG. 11 are simply examples. If there is only one user, the exemplary display screen of FIG. 9 could be used. As added security for one user, box 1207a1 and 1207a2 in FIG. 12 could be used with the display screen. This would prevent someone else from using the weightless scale system. With multiple user display screen 1200 being a touch screen as in another embodiment, the user presses code box 1207a2 which activates that box to enter her security code therein using keypad 1209, then touches code box 1207a2 which then activates the system. In another embodiment, the user uses box 1207a1 to enter his/her user name. Touching either the user name box 1207a1 or code box 1207a2 accesses the scale system for the user. Keypad 1209 is capable of entering alpha and numeric characters as is known, similar to a cell phone keypad with a text messaging functionality.

If a new user is to be added, the user presses the touch screen switch of Add new user box 1208, which is configured to cause a second row of boxes 1207b1 and 1207b2 to appear on the screen. The new user enters their user name in box 1207b1 using keypad 1209, then enters their security code in the same manner as the first user. Pressing the second user's name in box 1207b1 activates the system for the second user. The same procedure is followed for adding additional users, as indicated by the dashed lines of boxes 1207c1 and 1207c2. The multiple user display screen of FIG. 11 might be used, as one example, in a family situation where the weightless scale system is installed in a home. Once the system is activated for one of the multiple users, that one user is able to activate any of buttons 1203, 1204, 1205 and 1206. Only button 1203, current settings, is not shown in FIG. 9 and is newly added in FIG. 12. Button 1203 and its functionality, however, could also be included in the display screen of FIG. 9. Button 1203 allows for a display of the current settings to be displayed as a convenience item to refresh the user's memory as to the weightless scale system's current settings.

Alternative to the use of keypad 1209, a USB port provided on display 18 is used to connect a keyboard, or other data entry device, to the display for entering the user name and/or code data. Also alternatively, if a touch screen is not used, a second USB port on display 18 is used to connect a mouse for navigating the display screen and making selections.

If change current settings button 1204 is activated, a change default settings display screen, such as the exemplary screen shown in FIG. 10, appears on display 18 and the user proceeds to select their desired measurements as described with respect to FIG. 10.

As one operational example, if Susan is the selected user and she has inputted a benchmark weight of 110 lbs., as in the exemplary display of FIG. 8, then digital display 1201 for the weight measurement will display the differential number of her weight at the current weighing measured against her benchmark weight of 110 lbs. If her weight is now higher than her benchmark, the number displayed in digital display 1201 will have a + sign, and if her weight is now lower than her benchmark, the number displayed will have a − sign. In a similar manner, if David is the selected user, and he has inputted a benchmark weight of 160 lbs., then the displayed number when David uses the scale will have been measured against the 160 lb. benchmark and the appropriate + or − number will be displayed on digital display 1201.

FIG. 13 is an alternative exemplary multiple user access display screen 1301 for access to the weightless scale system where there are multiple users. FIG. 13 is particularly useful where there are many multiple users, such as when the weightless scale system is used in a facility, such as a health care facility, or for a group usage, such as an athletic team or a corporate employee health benefits office. In FIG. 13, a user is designated by entry of a user name and/or a user code in data box 1303 using keypad 1305. As in FIG. 12, access display screen 1301 is preferably a touch screen, although an external and mouse can alternatively be used by being connected to USB ports on display 18, as described in FIG. 12. The user touches data box 1303 to activate the connection of keypad 1305 to data box 1303 and then enters the desired name or code using keypad 1305. The user then presses Enter box 1309, whereupon the weightless scale's database retrieves the user associated with the name or code entered and that person is now the active user of the system.

Alternatively, a user can press show list box 1311 whereupon a scrollable list of users 1313 appears on the screen and the list is scrolled down to highlight the desired user name. Enter box 1309 is then pressed and the highlighted person's name is now the active user of the system. Scrollable list of users 1313 is shown in dashed lines in FIG. 13 to indicate that the scrollable list does not appear on the screen until the Show list box 1311 is pressed and Entered. Variations can be made to access display screen 1301 of FIG. 13. For example, to maintain privacy, it might be desired not to have a scrollable list of users shown, in which case only Enter name/code box 1303 would appear on the screen. On the other hand, it might be desired just to use the scrollable list for convenience, in which case only scrollable list 1313 would appear, and not Enter name/code box 1303 when access display screen 1301 appears on display 18.

A concern in some circumstances as to health conscious use of the scale, especially in health care facilities or other usage where a larger group of users are involved, is the constant touching of controls, such as a touch pad, and the desire to avoid unintentional transmission of germs and the like from the constant touching by many users of the scale assembly. Also there may be times when a user has something on their hands from daily activity and they might otherwise have to take the added time to wash their hands before using the scale assembly. The disclosed weightless scale system has the added optional feature for use without any physical contact of controls on the display screen of FIG. 13 or any other display screen. This can take the form of gesture, voice or use of a remote control device.

### Procedural Steps for Weightless Scale Setup

Procedural steps for using the weightless scale system are next described as examples of some of the various procedures that can be used with the weightless scale system.

The user steps on platform 10 of the weighing scale. A system activation signal is generated, a weight measurement is performed and is converted to a digital signal either in platform 10 or in computer 14, and is sent to display 18. If this is a first time use, the user can either make this current weight reading the default weight reading or can enter a different target goal weight. The user further makes its selection as to operational modes and other default settings, as appropriate. For example, the user selects other body composition measurements, such as body muscle, body mass, % water, body temperature and height, and each can be selected to show an actual or differential reading.

With this procedure, the user designates a default as regards the measurement or measurements to be made each time the scale is used. For example, a user may primarily be interested in seeing the weight differential on a regular basis. In that case, the default setting can be made to show only the weight differential, unless any other body composition item is selected at any particular use of the scale. This makes it convenient for the user when all the other measurements are not desired every time the scale is used.

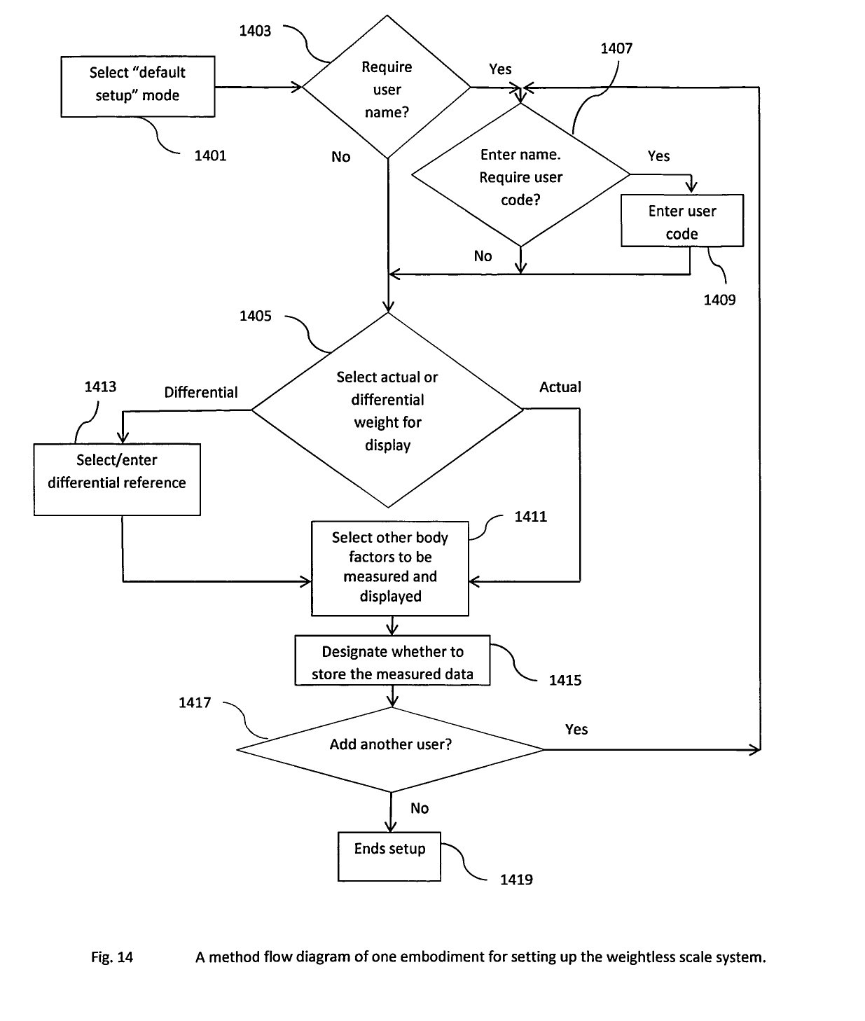

FIG. 14 is a flow chart method diagram that shows steps, according to one embodiment, for setting up the default settings of the weightless scale system. The purpose of this process is to set the default settings in accordance with preferences selected by one or more users. David is a fictitious user in this example. This setup can be performed with a weight placed on platform 10 which automatically activates the weightless scale system for this setup, and using the one or more display screens 18 of the weightless scale system. The setup can also be performed with appropriate system software loaded into computer 14 and use of a mouse, keyboard and monitor connected to computer 14. When the weightless scale is programmed, that is, set up, by use of computer 14, or by use of a remote computer such as when the weightless scale system is accessible through a wired or wireless network, the selections in setting up the weightless scale system are made without physically touching display 18 of the weightless scale system. If computer 14 is used for the setup, the weightless scale system is activated by use of a computer software program instead of the scale system being turned on by the sensing of a predetermined minimum weight on platform 10. The method explained here uses the procedure whereby a weight is placed on platform 10 to activate the weightless scale system.

The user steps on platform 10 and thereby the weightless scale system is activated and a display screen, such as the exemplary display screens of FIGS. 9, 12-13, appears on display 18. In the process description of FIG. 14, it is assumed that multiple user display screen 1200 in FIG. 12 is the one activated in the weightless scale system. The process starts with step 1401 where the user selects the default setup mode. This corresponds to button 1204 in FIG. 12. At the initial use of the weightless scale system, no user name or user selections have yet been entered so it is understood that change-current-settings associated with button 1204 represents entering the initial settings. Thereafter, button 1204 refers to changing the initial or latest subsequent settings entered.

The next step 1403 asks whether designation of a user name is required. If, for example, single user display screen 90 in FIG. 9 were used, then the answer at its step 1403 as applied to display screen 90 would be no, that no user name needs to be entered, and the process goes to an equivalent step 1405 for display screen 90. However since multiple user screen 1100 is used in this description, the answer at step 1403 is yes. The process then moves to step 1407 where a user name is entered, or if the name is already entered in the system (not the situation in an initial setup), then that name is designated as the user, such as by pressing box 1207b1 in FIG. 12 if David is the user. If the user's name is not yet entered into the scale system, the user enters its name by pressing add new user box 1208 in FIG. 12 and follows the new user entry process as described with regard to FIG. 12. For example, the user name could be an actual name, such as “Susan,” or the user name could be a number or alphabetic letter, such as user #1, or user A. The digital entry can be any indicator the user desires as the user name, and is made using keypad 1209 on the display or alternatively by connecting a keyboard and mouse, or other data entry device, via USB ports on the display.

After entry or designation of the user, step 1407 asks whether a user security code is required. No code entered in the code box associated with the designated user name indicates that no code is required and the process proceeds to step 1405. If a code is chosen to be required, the code is entered at step 1409. If this were not the initial system setup and a code had been designated for the user, which would be a code entered in box 1207b2 for user David as shown in FIG. 12, for example, then the answer to the query at step 1407 is yes, and David enters his user code at step 1409. The entry of the user name and user code into the system after it has been inserted into the respective data box could be executed by touching the respective box after the data has been inserted into the box, for example. This functions to activate the touch screen switch, whereby the user name and code are entered and David is now the scale system user, and data bases associated with David are accessible for purposes of storing and retrieving measurement data.

At step 1405, David selects whether the scale system is to display an actual or differential weight reading. This corresponds to button 1 a) on change default settings display screen 101 in FIG. 10. If actual weight is selected, the process advances to step 1411. If differential weight is selected, the process moves to step 1413 where the differential weight reference is inputted. This is performed by entering a desired reference date, which corresponds with button 2 in FIG. 10, or by entering a target goal weight, which corresponds to button 1 b) in FIG. 10. If, for example, the user selects a one month earlier date at this point, then the current reading is measured against the weight reading one month earlier. If the one month earlier reading was 111.5, and the current reading is 112.3, then the displayed differential weight would be +0.8. From step 1413, the process proceeds to step 1411.

At step 1411, David selects any other body composition factors that are to be measured and displayed. This corresponds to button 3 in FIG. 10 and for clarity the detailed steps for each other body factors is not shown in FIG. 14 but are as described with reference to the use of button 3 in FIG. 10. For example, David might select the body mass factor at button 3 b.) in FIG. 10 and designate whether the actual body mass figure, or a differential body mass figure referenced back to the body mass figure measurement from an earlier date, or referenced to an inputted target goal body mass figure.

After making the one or more selections at step 1411, the process moves to step 1415 where David chooses whether to set the selections for this weighing only or to store the selections as new default settings. This corresponds to buttons 4 and 5 in FIG. 10.

At next step 1417, the question is asked whether to add another user. If another user is to be added, the process goes back in a feedback loop to step 1407 and the same process thereafter as described is repeated for the new user. This feedback loop continues for each new user that is added. When the answer to the question of step 1419 is no, that no more users are to be added, the process moves to step 1419 where the set up process ends.

If a user elects not to include a weight measurement (not shown), which corresponds to the selection available at button 3 f.) in FIG. 10, then the process of FIG. 14 would, after designating a “no weight” entry, bypass step 1405 and proceed instead from steps 1403, 1407 or 1409 directly to the selection of other body factors at step 1411.

### Procedural Steps for Weightless Scale Use

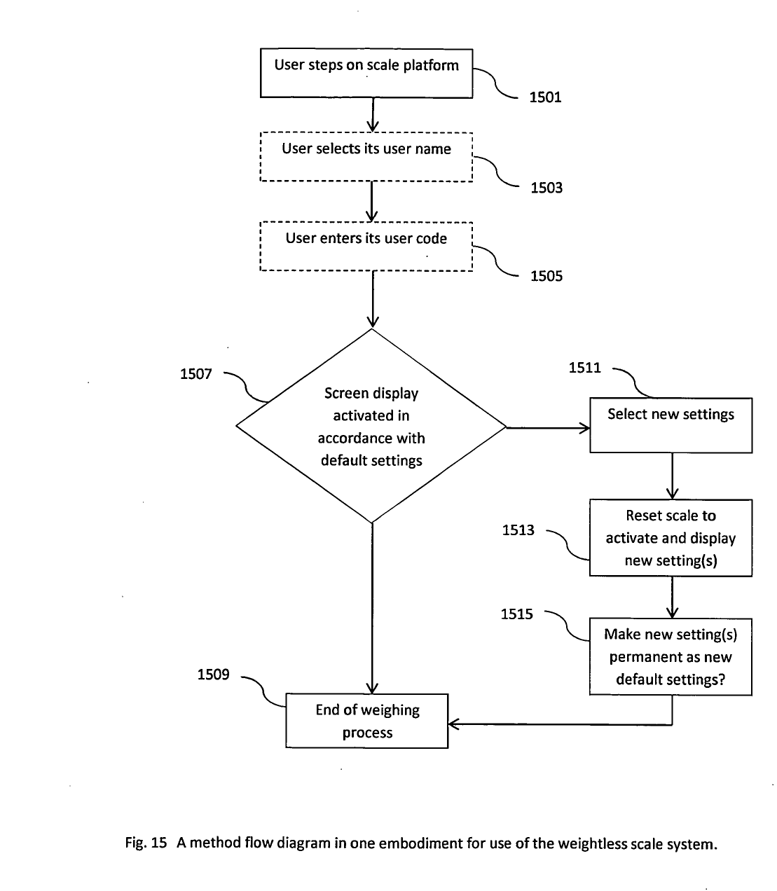

FIG. 15 is a flow chart method diagram that shows steps, according to one embodiment, in using the weightless scale system. At step 1501, the user steps on platform 10 of the weightless scale system to conduct a weighing. Steps 1503 and 1505 that follow are shown in dotted lines to indicate that the steps of the user entering its user name and its user code only apply if the user has set up the scale system to require use of a user name and user code in the default settings. If the user has elected not require a user name, then steps 1503 and 1505 would not apply.

Once the user has stepped on the scale platform, and optionally entered or not entered the name and code identifiers, the screen display is activated at step 1507 in accordance with the default settings. If, for example, the user has set the default to only show a differential weight measurement, then the screen will display a differential weight number, such as “+0.8” as an example. The screen display cuts off when the user steps off the scale which ends the weighing process at step 1509.

Optionally, the user can select new settings at step 1511. This corresponds to the exemplary procedure previously described with regard to FIG. 10, and the user selects the measurements to be performed and displayed according to its choosing.

Once the one or more selections are made, the user activates a “reset” indicator on the display screen at step 1513, and the measurement numbers are displayed for the new settings chosen by the user. For example, a user may regularly want to see only the differential weight, and accordingly the scale is set up for this in the default setting procedure (FIG. 14). This may be most efficient for the user in terms of time and effort in a daily or frequent weighing process. Occasionally, however, the user may want to check other body factor measurements. The described procedure for entering new settings allows for a convenient way to perform and view other measurements as well at the time of any weighing.

At step 1515, the user has the option of making the new setting permanent as the new default settings for the weightless scale. For example, there could be both a “save and exit” button and an “exit-do not save” button, or touch pads, on the display, for the user to use for entering this “save” or “do not save” instruction. This ends the weighing process as indicated at step 1509.

### Wireless External Network System

(1) Area Networks

In another embodiment, the weightless scale system is used in a wireless local area network (WLAN). In this embodiment, the weightless scale system includes one or more wireless network interface controllers and the weightless scale system is the access point for other client terminals in the network, and is also referred to as the base station in the network. A high speed connection is a part of the WLAN base station of the weightless scale system. Known types of high speed connections can be used, such a cable modems, different types of DSL, satellite broadband, ISDN, etc. The weightless scale's high speed connection connects the access point or gateway of the weightless scale system to all computer stations that are connected and have access to the WLAN network.

In some situations for a WLAN configuration of the weightless scale system there may be only one other client terminal. For example, an athletic facility might use the weightless scale system to transmit body composition data to another office, such as an administrative office. In another example, a health care facility might use the weightless scale system to receive patient data at a health care records office. Still another example is the use of the weightless scale system in a corporate health care benefits setting, where the employee participating in a heath care or heath training program could transmit employee information to the human resources office or to a medical station for the company.

In these exemplary uses, the weightless scale system can be spread out between buildings, or among a number of buildings with more than one client terminal, whether it be in an educational environment, such as part of the school's athletic or student health program, in a health care environment with medical and possibly housing facilities spread out across numerous buildings, or in a corporate setting as part of an employee health care benefits program where the company is composed of various distinct buildings devoted to different aspects of the company's business.

In these examples and other situations where diverse buildings or locations are connected by a local area network, they form a “campus” structure. Having to travel between buildings and locations to conduct and enter into records a basic health care measurement, such as measuring a weight change, or to engage in a more involved analysis of body composition data, is an obstacle that involves downtime and hence expense. Having the body composition measurement system include an integrated WLAN capability gives the benefits of having desired body composition data quickly accessible by a person who is to use that information, whether it be a clerk recording the information into the person's records, or a doctor conducting an analysis of the user's body composition factors, over any time period desired and over any past data range desired. A weightless scale system with an integrated WLAN capability further allows for independent verification of the measured data without the person having to be there with the user to verify the body composition measured data.

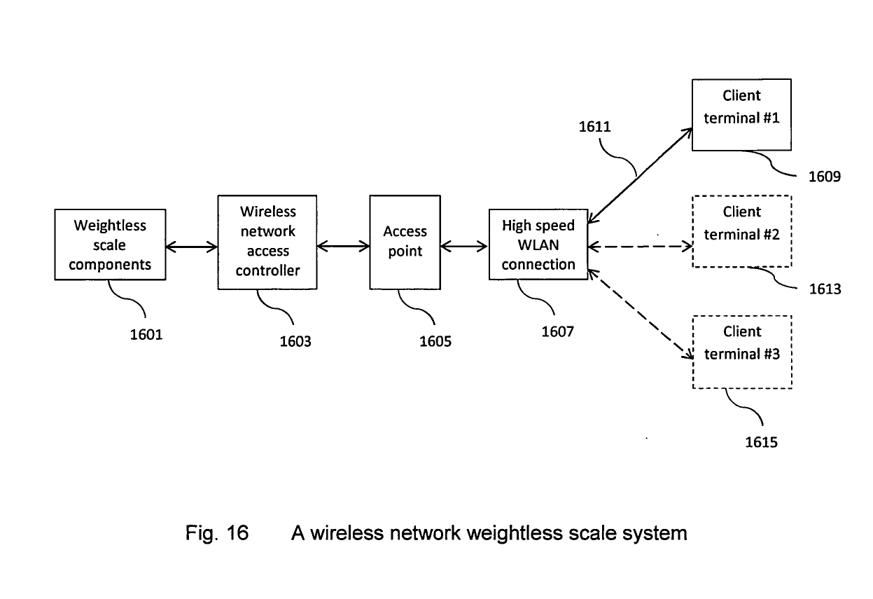

The block diagram of FIG. 16 shows basic components of a wireless network weightless scale system. Components of the wireless scale system 1601 include components already presented in the figures and related descriptions, and those descriptions are not repeated. In addition to those components and with further reference to FIG. 16, a wireless network weightless scale system has a wireless network access controller 1603 connected to an access point 1605 which could be a data output port of one component of weightless scale components 1601 with a suitable interface for wireless access. Access point 1605 is connected to a high speed WLAN connection 1607. For example, a Wi-Fi antenna system is connected to access port 1605 for wireless communication. One or more routers (not shown) may also be a part of the local area network depending on details of the scope of the network's coverage and distance factors.

While the wireless weightless scale system is described for use in a wireless local area network (WLAN), the network may include both wired and wireless connections. This embodiment further includes the wireless network weightless scale system used in any dedicated network that is not openly accessible to the public. The network of this embodiment includes Ethernet local and wide area networks (LAN, WAN), optical networks and wired networks, as a few examples. Further, a hybrid network can be used in either a WAN or LAN in which certain parts thereof are interne accessible and certain other parts thereof are not publically accessible and are a part of the WAN or LAN only.

High speed WLAN connection 1607 is operationally connected, preferably by a wireless communication channel 1611, to at least one client terminal 1609. Other client terminals, such as 1613 and 1615, are indicated with dashed lines to illustrate that they could, but do not have to be, added as part of the wireless network weightless scale system.

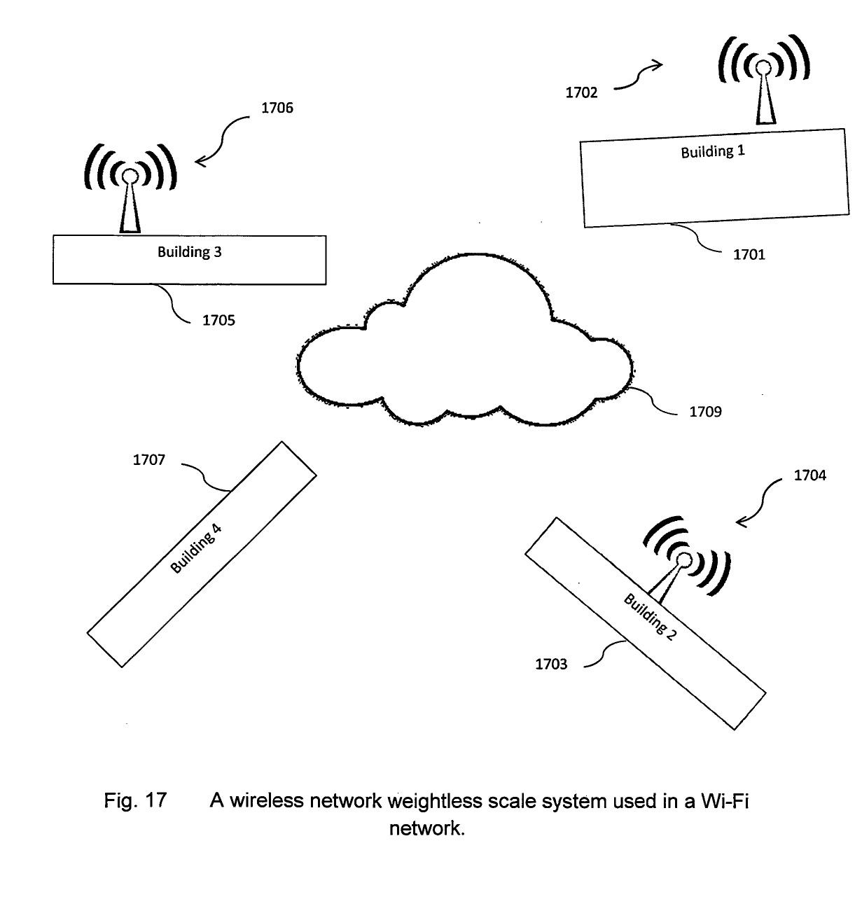

FIG. 17 is an illustration of an example of a wireless network weightless scale system of the type shown in the block diagram of FIG. 16. For exemplary purposes, the wireless network WLAN weightless scale system in FIG. 17 is used in a campus type health care facility. A first building 1701, in this example, is a dormitory kind of housing provided to residents in which basic health care needs are provided. A second building 1703 houses the administration office, including the patient records office, of the facility. A third building 1705 is a medical office building nearby, but not on the campus of the health care facility, in which the doctor's office is located in which the primary care physician for residents of the health care facility has his office. Building 1707 is a fourth building that is a part of the health care facility's campus, such as a second dormitory residence, but is one that is not concerned with the body composition measurements made in building 1701. Hence building 1707 is not made a part of the wireless network weightless scale system.

Each building 1701, 1703 and 1705 has an antenna system 1702, 1704 and 1706, respectively, connected to a computer in its respective building that has the capability to enable bi-directional communication with other buildings and other antenna systems in the network. Cloud 1709 represents with wireless WLAN communication system beyond the antenna systems at buildings 1701, 1703 and 1705. One typical use of the wireless weightless scale system in this environment will be described to explain the operation and benefits of the wireless network weightless scale system in this embodiment.

Daily weightings are conducted of the residents in building 1701. Because there are multiple residents using the scale, a name and a security code are established for each user. Due to the varying health condition of each resident, the default settings for the weightless scale are set up separately for each user based on the specific information to be monitored for a particular resident. Staff in building 1701 can conduct, or assist with, the weighing procedure for each resident. The staff person, for example, might be a licensed practical nurse (LPN) and some residents, as a further example, might be able to be instructed on use of the system by themselves. In this setting, the weightless scale system physically located in building 1701 is the base station or primary access point of the LAN. The patient records office in building 1703 and the primary physician's office in building 1705 are clients in the network with secondary access points that provide access, through use of appropriate user codes as known and used in LAN and WAN systems, to the base station.

A weighing procedure consisting of the measurement and display of one or more body composition factors is conducted for a resident first user in building 1701. The wireless network weightless scale system is activated for connection to the Wi-Fi network. In this example, LAN and Wi-Fi network are used interchangeably. An operator at the computer in patient records at the client station in building 1703 accesses the network to receive results in real time from the weighing procedure. Information from the first user weighing procedure is transmitted to the computer in patient records, reviewed by the operator there and stored under the first user's name in the computer to provide a backup to the same information already stored in the computer at the base station of the wireless network weightless scale system. The operator prints out the results of the procedure and puts it in the first user's patient records file.

If, for example, one of the health care facility's functions is to periodically review the residents' body composition data that has been compiled through regular use of the weightless scale, or arrange that data is a different presentable format, this function can be performed in the patient records office in building 1703. Assume, as a further example, that the first user's measurement results at this weighing shows an abnormal change in one or more body composition factor measurements. The current weighing information, and a past history of data going back to a predetermined time from the first user's data stored in memory is sent via the Wi-Fi network to the first user's primary physician in building 1705. From a review of the received information, the primary physician wants to see a repeated current measurement for verification of the latest first user's results and wants a photograph as well of the first user. Further, the manager of patient records needs to be a part of this communication so that the first user's records are promptly updated and any outside person or persons are informed, as necessary.

The wireless network weightless scale system is used to connect the two client computers with the base station and conduct this three-way conference. Other communication capabilities as contained in other embodiments, such as the weightless scale system including a photograph camera, a video camera, and/or a telephone or other audio channel, provide the desired communication features and the transmission of a photograph of the first user and results of any body composition factor measurement as may be designated in the course of the conference call. While this example describes a bi-directional thee-party communication, the wireless network weightless scale system allows as well for a unidirectional communication within the wireless network where the stored data for any particular user is accessible at any time by the patient records office and/or the primary physician from computer 18 of the wireless network weightless scale system's computer. (ref., e.g., FIGS. 5, 12).

(2) Internet

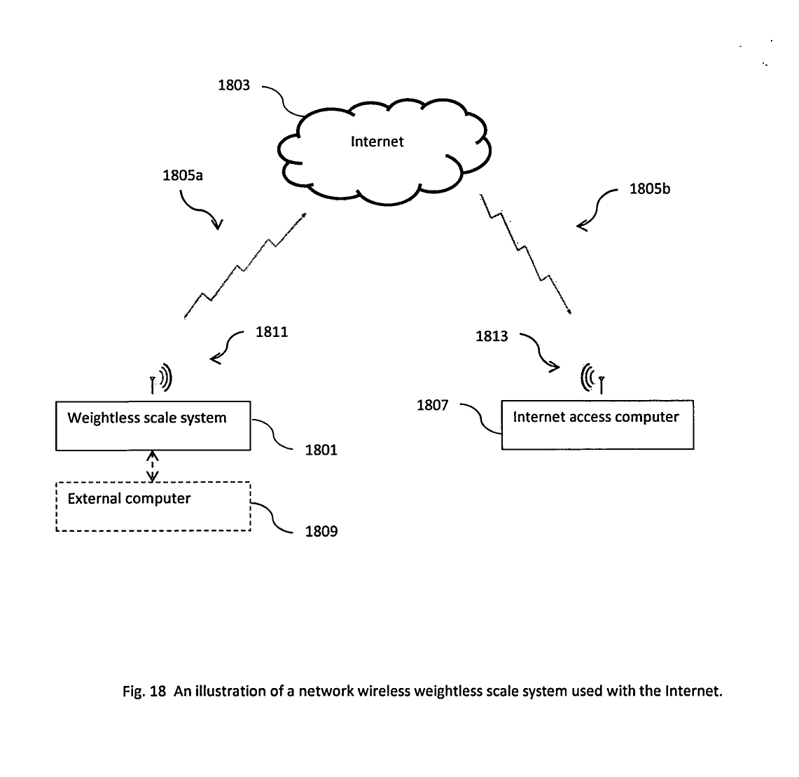

FIG. 18 is an illustration of another embodiment of the wireless network weightless scale system where the weightless scale system 1801 is connected to the Internet 1803 through wireless communication channels 1805a and 1805b, which allows for communication exchange and data access, through appropriate security codes, to one or more other locations 1807 via the Internet. In another embodiment, another computer station 1809, such as one in the same building as weightless scale system 1801, or in another building as illustrated in FIG. 17 with respect to a Wi-Fi wireless network, is also be connected to communicate with weightless scale system 1801 through an Internet or other type connection.

Weightless scale system 1801 communicates information and data through an antenna system 1811 to Internet 1803, and the information and data is accessed at one or more locations 1807 through an antenna system 1813 at each receiving station. While FIG. 18 illustrates use of radio frequency (RF) wireless Internet communication channels, it is understood that communication channels 1805a and 1805b can consist of or comprise other types, or combinations, of communication channels, where an antenna system may not be necessary, such as by the use of wired or optical networks.

The communication can be bi-directional or uni-directional, and participants and types of communications can be as described previously in the embodiment of FIG. 17. The only difference is that FIG. 17 is limited in network scope to a local or wide area network, such as a Wi-Fi network, whereas FIG. 18 illustrates a wireless network with a broader scope of coverage by the Internet's world-wide network. A remote location 1807 anywhere with access to the Internet accesses via the Internet the weightless scale information and data through a URL Internet address and appropriate security codes associated with weightless scale system 1801. This gives the remote user various options which apply equally to use of a Wi-Fi wireless network as in FIG. 17 or the Internet as in FIG. 18. For example, the remote user can view the weightless scale measurements in real time as the scale is being used. Alternatively or in addition, stored data in the weightless scale system can be accessed by the remote user. This capability gives the benefit of a remote user being able to view and discuss the weightless scale data during the course of, for example, a telephone or video conference concerning the user of the weightless scale.

### Embodiments Using Alternative Activators

Activation of components of the weightless scale system have been described with reference to the use of touch screen displays, toggle switches and buttons, as some examples. However the disclosure is not limited to these exemplary actuator apparatuses and devices. The weightless scale system can be controlled by known methods of voice commands, body gestures and voice actuation. A display screen, such as the examples illustrated in FIGS. 4, 6-7, can also be controlled by a remote control device that transmits digital signals as commands that correspond to activation and controls of the weightless scale system.

For example, in one embodiment, a user controls the activation of a particular body composition factor measurement sensor and system, and display format, in display 73 of FIG. 7 by use of voice actuation technology as known, or by use of known remote control devices analogous to a T.V. remote control device. Body gesture, such as described in U.S. Pat. No. 7,379,563 for example, is another usable control mechanism. Such control without a physical touching may be an important consideration in terms of health conscious uses of the weightless scale system. Such alternative activators prevents a user from having to physically step off of platform 10 when display 18 is mounted a distance away from the platform in order to change to a desired measurement from a default setting, for example. This further enhances the user's experience as regards convenience and ease of use in using the weightless scale system of the disclosure.

The disclosure includes other embodiments in addition to the above-described embodiments without departing from the spirit of the disclosure. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the disclosure.

1. A weightless scale system comprising:
a platform configured to support an item to be weighed, measure weight and output a weight data of the item as a body composition factor measurement,
a computer operatively connected to the platform for receiving and processing the weight data from the platform, and outputting processed data,
a memory operatively connected to the computer for storing the weight data with a date associated with each stored weight data,
a display operatively connected to the computer for receiving the processed data from the computer and using the processed data to display a selected weight measurement on a display screen
a control panel operable by a user to select an actual or a differential weight for display, wherein the differential weight is a difference between a most recent weight data outputted from the platform and a weight data outputted from the platform from a selected earlier date,
wherein the computer comprises a scrollable calendar program configured to allow the user to select at least one calendar date as a benchmark date for calculating the differential weight based on the selected benchmark date when the user selects the differential weight for display, and
wherein the selectable one calendar date is any date from the date the weightless scale system was first used and weight data was stored in the memory to the date of a most recent weighing on the weightless scale system.

2. The weightless scale system of claim 1, wherein the at least one calendar date comprises two calendar dates selectable by the user to identify a range of dates between which the differential weight is to be measured and displayed as the differential weight.

3. The weightless scale system of claim 1, wherein the item to be weighted is a person.

4. The weightless scale system of claim 1, wherein the memory is a component of the computer.

5. The weightless scale system of claim 1, wherein the control panel comprises a touch screen touchable by the user to activate user selections as part of a display screen on which a weight measurement is displayed.

6. The weightless scale system of claim 3, further comprising at least one system for performing a measurement of at least one body composition factor, selectable by the user, from the group of body mass, body muscle, % water, body temperature and body height.

7. The weightless scale system of claim 6, wherein the measurement of at least one body composition factor is selectable by the user for display and for storing data of the at least one body composition factor in the memory.

8. The weightless scale system of claim 1, further comprising a camera system for taking a picture of at least a portion of the item weighed on the weightless scale system.

9. The weightless scale system of claim 1, wherein the control panel comprises at least one control operable by one from the group of a gesture, a sound and a remote control, without a physical touching of the at least one control on the control panel by the user.

10. The weightless scale system of claim 9, wherein the sound is the users' voice.

11. The weightless scale system of claim 6, wherein the at least one system for performing a measurement of at least one body composition factor comprises an infrared technology measurement system.

12. The weightless scale system of claim 1, wherein the display comprises a plurality of displays configured to displayed at least one body composition factor measurement and contain at least one body composition measurement sensor system.

13. The weightless scale system of claim 1, wherein the display is at least one display and the at least one display is physically separate from the platform.

14. The weightless scale system of claim 1, wherein the platform comprises a converter for converting the measured weight to output a digital weight data.

15. A method of using a weightless scale system comprising the steps of:
positioning an item on a platform of the weightless scale system,
selecting a differential weight measurement from a choice of an actual or a differential weight measurement,
designating a benchmark date from a scrollable calendar of the weightless scale system wherein the scrollable calendar comprises all dates from the time data was first stored in a memory of the weightless scale system, and
viewing a differential weight on the display as the difference between a current weight and a stored weight associated with the designated benchmark date.

16. A wireless network weightless scale system comprising:
a platform configured to support an item to be weighed, measure weight and output a weight data of the item as a body composition factor measurement,
a computer operatively connected to the platform for receiving and processing the weight data from the platform, and outputting processed data,
a memory operatively connected to the computer for storing the weight data with a date associated with each stored weight data,
a display operatively connected to the computer for receiving the processed data from the computer and using the processed data to display a selected weight measurement on a display screen
a control panel operable by a user to select an actual or a differential weight for display,
wherein the differential weight is a difference between a most recent weight data outputted from the platform and a weight data outputted from the platform from a selected earlier date,
wherein the computer comprises a scrollable calendar program configured to allow the user to select at least one calendar date as a benchmark date for calculating the differential weight based on the selected benchmark date when the user selects the differential weight for display, and
wherein the selectable one calendar date is any date from the date the weightless scale system was first used and weight data was stored in the memory to the date of a most recent weighing on the weightless scale system, and
a wireless network access controller operatively connected to the weightless scale system,
an access point connected to the wireless network access controller, and
a wireless connection to the access point configured to connect the weightless scale system to a wireless network.

17. The wireless network weightless scale system of claim 16, wherein the wireless network is one from the group of a local area network and a wide area network.

18. The wireless network weightless scale system of claim 16, wherein the wireless network is the Internet.
